(19) United States
(12) Patent Application Publication
(10) Pub. No.: US 2026/0194840 A1
(43) Pub. Date: Jul. 9, 2026

(54) IMAGE FORMING APPARATUS

(71) Applicant: CANON KABUSHIKI KAISHA, Tokyo (JP)

(72) Inventor: Tadashi Fukuda, Tokyo (JP)

(21) Appl. No.: 19/371,291

(22) Filed: Oct. 28, 2025

(30) Foreign Application Priority Data
Jan. 7, 2025 (JP) 2025-002144

(51) Int. Cl. G03G 15/08; G03G 15/00; G03G 15/09

(52) U.S. Cl. CPC G03G 15/0898; G03G 15/0891; G03G 15/0921; G03G 15/0942; G03G 15/50

(57) ABSTRACT

An image forming apparatus includes a developing device provided with a developing container, a rotatable developing member and a supplying screw, a sucking portion for sucking the developer scattered inside the developing container, a vibration applying portion for applying vibration to the developing container. The rotatable developing member is rotationally driven by a first driving portion. The supplying screw is rotationally driven by a second driving portion. At start of a vibration applying operation by the vibration applying portion, a controller controls the first driving portion so as to become a state in which the rotatable developing member is rotationally driven, and controls the second driving portion so as to become a state in which rotational drive of the supplying screw is stopped.

### BACKGROUND

### Field of the Technology

The present invention relates to an image forming apparatus provided with a developing device which develops an electrostatic latent image formed on an image bearing member.

### Description of the Related Art

In an image forming apparatus using an electrophotographic type, an electrostatic latent image formed on an image bearing member is developed into a toner image by a developing device. As such a developing device, those in which two-component developer including toner and a magnetic carrier are conventionally used, and a configuration in which the developer is carried by a developer carrying member to develop the electrostatic latent image on the image bearing member is generally known.

In recent years, as a printing speed is increased, toner scattering from such a developer carrying member becomes problematic, and in Japanese Patent Application Laid-Open No. 2023-174404, a configuration provided with a duct for sucking scattering toner is disclosed. In addition, in Japanese Patent Application Laid-Open No. 2020-003563, a configuration provided with a vibration applying device which causes the scattered toner to fall with vibration and collect the scattered toner is disclosed.

However, even with the configurations provided with the duct which performs the sucking of the scattering toner and the vibration applying device, if an inside of a developing container in which the developer is accommodated is in a positive pressure state in which a pressure thereof is higher than that of an outside thereof, by the developer, which has fallen by the vibration from the vibration applying device (vibration applying portion), not being sucked by the duct but scattered to the outside of the developing container, a periphery of the developing device may be contaminated.

### SUMMARY

In one aspect of the present disclosure, a purpose is to suppress a developer, which has fallen by vibration from a vibration applying portion, to scatter to an outside of a developing container.

In addition, another purpose of the present disclosure is an image forming apparatus comprising: an image bearing member; a developing device provided with a developing container for accommodating a developer including toner and a carrier, a rotatable developing member for carrying and feeding the developer to develop an electrostatic latent image formed on the image bearing member and a supplying screw for supplying the developer to the rotatable developing member while feeding the developer; a sucking portion configured to suck the developer scattered inside the developing container; a vibration applying portion configured to apply vibration to the developing container; a first driving portion configured to rotationally drive the rotatable developing member; a second driving portion configured to rotationally drive the supplying screw; and a controller, wherein at start of a vibration applying operation by the vibration applying portion, the controller controls the first driving portion so as to become a state in which the rotatable developing member is rotationally driven, and controls the second driving portion so as to become a state in which rotational drive of the supplying screw is stopped.

In addition, another purpose of the present disclosure is an image forming apparatus comprising: an image bearing member; a developing device provided with a developing container for accommodating a developer including toner and a carrier, a rotatable developing member for carrying and feeding the developer to develop an electrostatic latent image formed on the image bearing member and a supplying screw for supplying the developer to the rotatable developing member while feeding the developer; a sucking portion configured to suck the developer scattered inside the developing container; a vibration applying portion configured to apply vibration to the developing container; a first driving portion configured to rotationally drive the rotatable developing member; a second driving portion configured to rotationally drive the supplying screw; and a controller, wherein during an image forming operation, the controller controls the first driving portion so as to become a state in which the rotatable developing member is rotationally driven at a first speed, and controls the second driving portion so as to become a state in which the supplying screw is rotationally driven at a second speed, and wherein at start of the vibration applying operation by the vibration applying portion, the controller controls the first driving portion so as to become the state in which the rotatable developing member is rotationally driven at the first speed, and controls the second driving portion so as to become a state in which the supplying screw is rotationally driven at a third speed slower than the second speed.

In addition, another purpose of the present disclosure is an image forming apparatus comprising: an image bearing member; a developing device provided with a developing container for accommodating a developer including toner and a carrier, a first rotatable developing member for carrying and feeding the developer to develop an electrostatic latent image formed on the image bearing member, a second rotatable developing member disposed opposite to the first rotatable developing member and to which the developer remaining after the electrostatic latent image being developed by the first rotatable developing member is delivered, the second rotatable developing member carrying and deeding the developer to develop the electrostatic latent image by the second rotatable developing member after the electrostatic latent image being developed by the first rotatable developing member, and a supplying screw for supplying the developer to the first rotatable developing member while feeding the developer; a sucking portion configured to suck the developer scattered inside the developing container; a vibration applying portion configured to apply vibration to the developing container; a first driving portion configured to rotationally drive the first rotatable developing member and the second rotatable developing member; a second driving portion configured to rotationally drive the supplying screw; and a controller, wherein at start of the vibration applying operation by the vibration applying portion, the controller controls the first driving portion so as to become a state in which the first rotatable developing member and the second rotatable developing member are rotationally driven, and controls the second driving portion so as to become a state in which rotational drive of the supplying screw is stopped.

Further features of the present invention will become apparent from the following description of exemplary embodiments with reference to the attached drawings. The following description of embodiments is described by way of example.

### BRIEF DESCRIPTION OF THE DRAWINGS

FIG. 1 is a cross-sectional view of an outline configuration of an image forming apparatus according to an Embodiment 1.

FIG. 2 is a cross-sectional view of an outline configuration of a developing device according to the Embodiment 1.

FIG. 3 is a view illustrating a magnetic pole arrangement of a first developing roller according to the Embodiment 1.

FIG. 4 is a view illustrating a magnetic pole arrangement of a second developing roller according to the Embodiment 1.

FIG. 5 is a view illustrating a magnetic pole arrangement of a separating roller according to the Embodiment 1.

FIG. 6 is a schematic view illustrating a driving configuration of the developing device according to the Embodiment 1.

FIG. 7 is a cross-sectional view of a periphery of a second developing sleeve, a separating sleeve and a suction opening of a duct according to the Embodiment 1.

FIG. 8 is a cross-sectional view of an outline configuration illustrating a first example of Modified Examples of the developing device according to the Embodiment 1.

FIG. 9 is a cross-sectional view of an outline configuration illustrating a second example of the Modified Examples of the developing device according to the Embodiment 1.

FIG. 10 is a cross-sectional view of an outline configuration illustrating a third example of the Modified Examples of the developing device according to the Embodiment 1.

FIG. 11 is a graph showing a relationship between a peripheral speed ratio of a developing roller and a peripheral speed ratio of a developer screw, which satisfies a formula a, in an Embodiment 2.

FIG. 12 is a control flowchart which executes control for collecting scattered toner in an Embodiment 3.

### DESCRIPTION OF THE EMBODIMENTS

### Embodiment 1

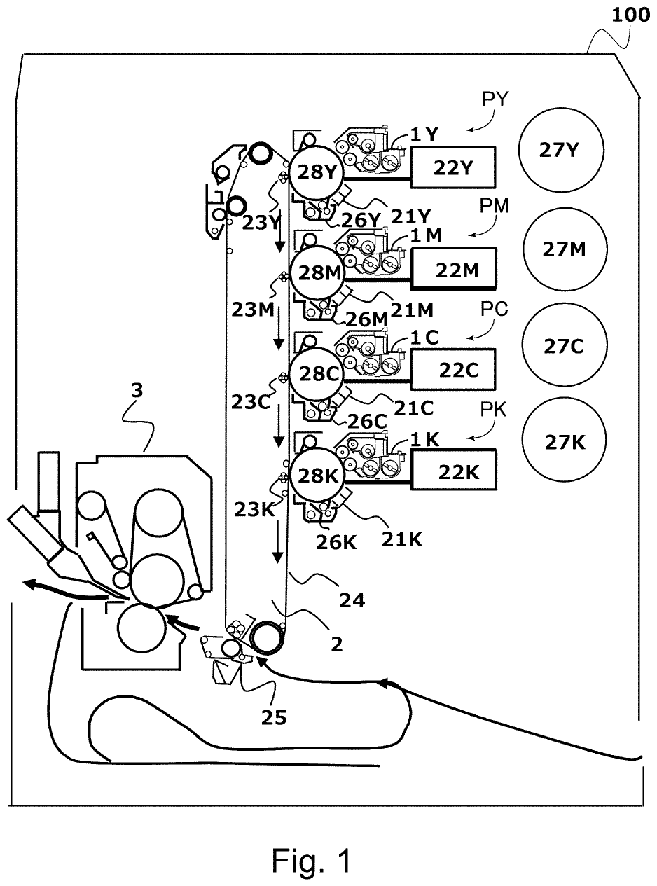

An Embodiment 1 will be described using FIG. 1 through FIG. 10. First, an outline configuration of an image forming apparatus in the present Embodiment will be described using FIG. 1.

### [Image Forming Apparatus]

An image forming apparatus 100 is a full-color image forming apparatus, and in the present Embodiment, is an MFP (Multi-Function Peripheral) which has a copying function, a printing function and a scanning function, for example. In the image forming apparatus 100, as shown in FIG. 1, image forming portions PY, PM, PC and PK, which perform an image forming process for toner images of four colors of yellow, magenta, cyan and black, respectively, are provided in parallel.

The image forming portions PY, PM, PC and PK for each color include primary chargers 21Y, 21M, 21C and 21K, developing devices 1Y, 1M, 1C and 1K, exposure devices (optical writing portion) 22Y, 22M, 22C and 22K, photosensitive drums 28Y, 28M, 28C and 28K, and cleaning devices 26Y, 26M, 26C and 26K, respectively. In addition, the image forming apparatus 100 includes a transfer device 2 and a fixing device 3. Incidentally, since configurations of the image forming portions PY, PM, PC and PK for each color are substantially the same, hereinafter, description will be made using the image forming portion PY representatively.

The photosensitive drum 28Y as an image bearing member is a photosensitive member which includes a photosensitive layer composed of resin such as polycarbonate containing an organic photo conductor (OPC), and is configured to be rotated at a predetermined speed. In the present Embodiment, a linear speed of a surface of the photosensitive drum 28Y is set to 650 mm/s. The primary charger 21Y is constituted by corona electric discharge electrodes disposed around the photosensitive drum 28Y, and charges the surface of the photosensitive drum 28Y with generated ions.

In the exposure device 22Y, a scanning optical device is incorporated, and by exposing the charged photosensitive drum 28Y based on image data, the exposure device 22Y lowers a potential of an exposed portion, and forms an electric charge pattern (electrostatic latent image) which corresponds to the image data. The developing device 1Y transfers a developer accommodated therein to the photosensitive drum 28Y, and develops the electrostatic latent image formed on the photosensitive drum 28Y. The developer is constituted by a carrier and toner corresponding to each color being mixed, and the electrostatic latent image is visualized by the toner.

The transfer device 2 includes primary transfer rollers 23Y, 23M, 23C and 23K, an intermediary transfer belt 24, and a secondary transfer roller 25. The intermediary transfer belt 24 is wrapped around and rotatably supported by the primary transfer rollers 23Y, 23M, 23C and 23K and a plurality of rollers. The primary transfer rollers 23Y, 23M, 23C and 23K correspond to each color of Y (Yellow), M (Magenta), C (Cyan) and K (Black), respectively, in order from top to bottom in FIG. 1. The secondary transfer roller 25 is disposed outside the intermediary transfer belt 24, and it is configured so that a recording material can pass through between the intermediary transfer belt 24 and the secondary transfer roller 25. Incidentally, the recording material is a sheet such as, for example, a paper sheet and a plastic sheet.

Toner images of each color formed on the photosensitive drums 28Y, 28M, 28C and 28K are sequentially transferred onto the intermediary transfer belt 24 by the primary transfer rollers 23Y, 23M, 23C and 23K, and a color toner image, in which each layer of yellow, magenta, cyan and black is superimposed, is formed. The formed toner image is transferred, by the secondary transfer roller 25, onto the recording material conveyed from a cassette, etc., in which the recording material is accommodated. To the recording material onto which the toner image has been transferred, in the fixing device 3, pressure and heat is applied. As a result, the toner on the recording material is melted, and the color image is fixed to the recording material.

Developer storing portions 27Y, 27M, 27C and 27K are provided correspondingly to the developing devices 1Y, 1M, 1C and 1K, respectively, and in order from top to bottom, bottles accommodating the developer corresponding to each color of yellow, magenta, cyan and black are mounted in a replaceable manner. The developer storing portions 27Y, 27M, 27C and 27K are configured to be capable of feeding (replenishing) the developer to the developing devices 1Y, 1M, 1C and 1K corresponding to the colors of the developer stored therein.

For example, a toner weight ratio of the developer accommodated in the bottle is 80 to 95%, while the toner weight ratios of the developer in the developing devices 1Y, 1M, 1C and 1K are 5 to 10%. Therefore, when the toner is consumed by the development in the developing devices 1Y, 1M, 1C and 1K, the developer including the toner equivalent to the consumed amount is replenished thereto, and the toner weight ratios in the developing devices 1Y, 1M, 1C and 1K are maintained constant, respectively.

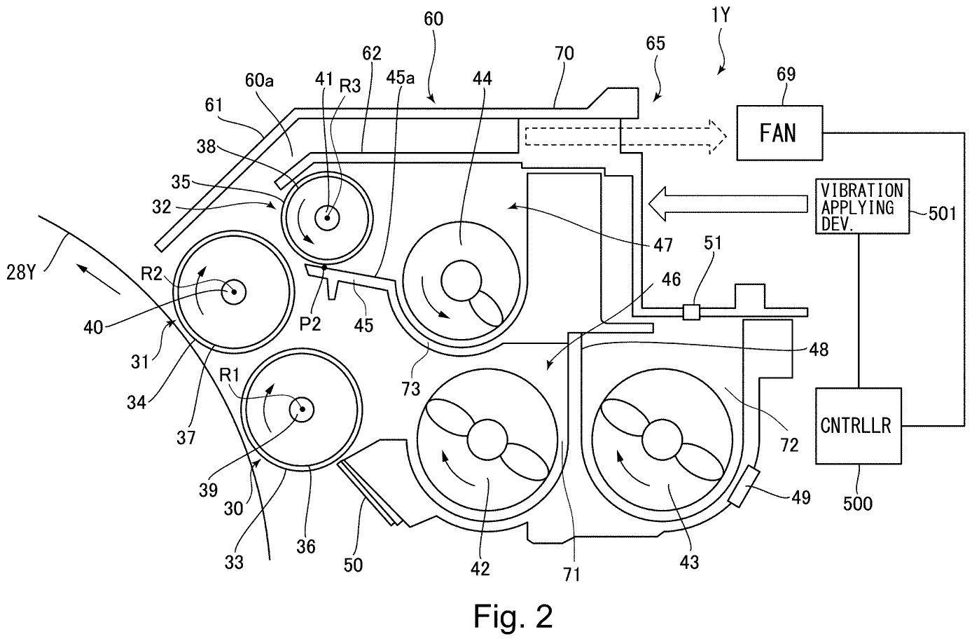

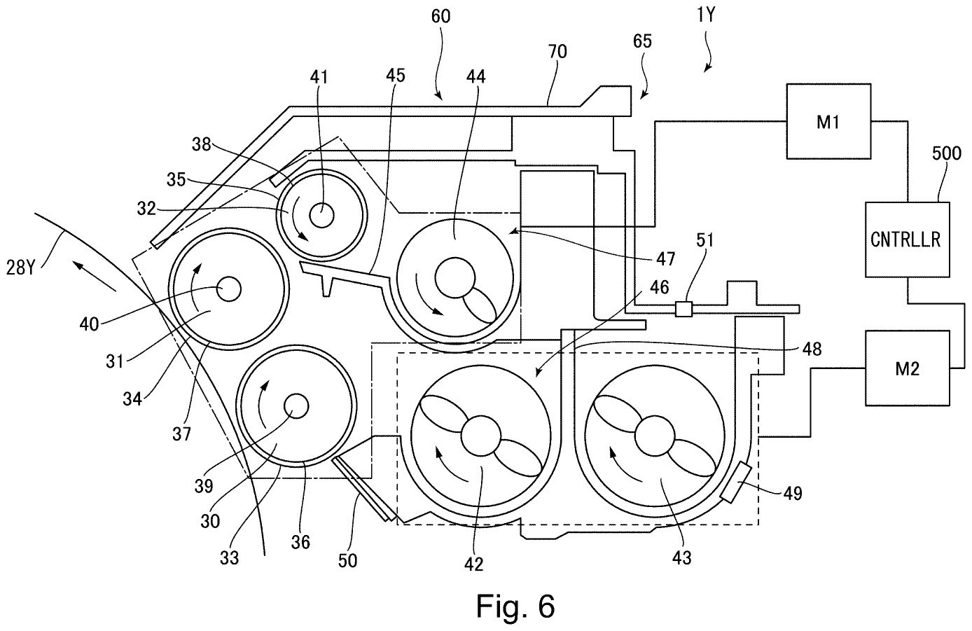

The image data input to the image forming apparatus 100 from an outside thereof is processed by a controller 500 (see FIGS. 2 and 6), and the image formation is performed through control at each step as described above. The controller 500 is provided with a CPU (Central Processing Unit), a ROM (Read Only Memory), a RAM (Random Access Memory), etc. The CPU reads out a program corresponding to a processing task from the ROM, loads the program in the RAM, and controls the operation of each configuration in the image forming apparatus 100 with collaborating with the loaded program. In other words, the controller 500 is configured to be capable of recording and utilizing various types of control data such as a value detected by a toner density detecting sensor and values of image data.

### [Developing Device]

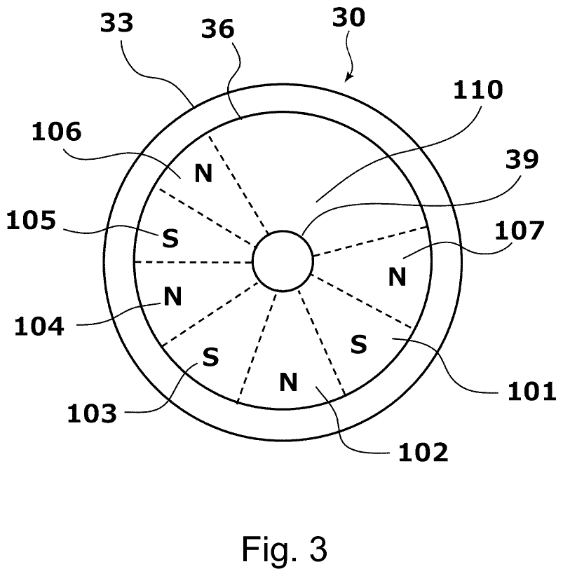

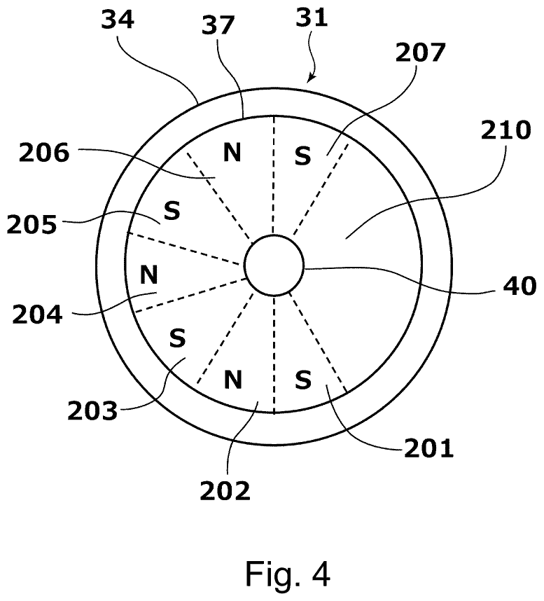

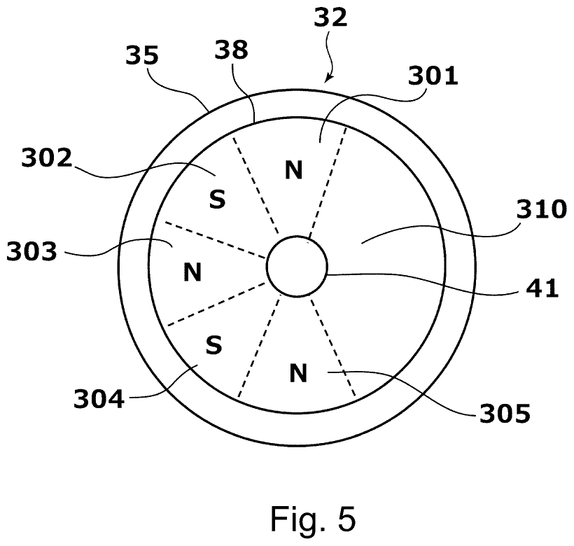

Next, the developing devices 1Y, 1M, 1C and 1K will be described in detail using FIG. 2 through FIG. 5. Incidentally, since the configurations of the developing devices 1Y, 1M, 1C and 1K are substantially the same, hereinafter, the developing device 1Y will be described representatively. FIG. 2 is an outline view describing the developing device 1Y shown in FIG. 1, and FIG. 3, FIG. 4 and FIG. 5 are outline views describing magnetic pole configurations of a first magnet 36, a second magnet 37 and a third magnet 38, which are disposed inside the developing device 1Y.

The developing device 1Y includes, as shown in FIG. 2, a first developing roller 30, a second developing roller 31, a separating roller 32, a developer supplying screw 42, a developer stirring screw 43 and a developer collecting screw 44, and these members are accommodated in a developing container 70.

The first developing roller 30 is a developer carrying member which is rotationally driven, and is disposed at a position adjacent to the photosensitive drum 28Y so as a rotational axis thereof to be approximately parallel to a rotational axis of the photosensitive drum 28Y. The first developing roller 30 includes a rotatable first sleeve (first developing sleeve) 33 and a first magnet (first developing magnet, fixed magnet) 36, which is disposed non-rotatably inside the first sleeve 33 and attracts the developer to a surface of the first sleeve 33 by magnetic force thereof. And the first developing roller 30 attracts (carries) the developer scooped up from the developer supplying screw 42 according to the magnetic force thereof, and develops the electrostatic latent image formed on the rotating photosensitive drum 28Y (on the image bearing member) with the developer.

To the first sleeve 33 (and a second sleeve 34, which will be described below) of the developing device 1Y, for example, a direct current developing bias of the same polarity as charging polarity of the primary charger 21Y, or a developing bias in which a direct current voltage of the same polarity as the charging polarity of the primary charger 21Y is superimposed to an alternating current voltage is applied. As a result, to the electrostatic latent image formed by the exposure device 22Y, reverse development, in which the toner charged to the same polarity as the charging polarity of the primary charger 21Y is adhered, is performed. In the present Embodiment, it is configured that the charging polarity of the primary charger 21Y and the direct current voltage of the developing bias are set to negative, and the reverse development in which the toner negatively charged is adhered to the electrostatic latent image is performed.

The first sleeve 33 is a non-magnetic cylindrical member having an outer diameter of 25 mm (radius r1=12.5 mm), and is rotationally driven about a rotation shaft 39. A rotational direction of the first sleeve 33 is, as indicated by an arrow in FIG. 2, clockwise, and in the present Embodiment, is an opposite direction to a rotational direction of the photosensitive drum 28Y. Therefore, the first sleeve 33 and the photosensitive drum 28Y are rotated in the same direction at a position where each opposes to the other.

In the present Embodiment, it is configured so as a linear speed of the surface of the first sleeve 33 to be 1.0 times (=650 mm/s) relative to the linear speed of the surface of the photosensitive drum 28Y. By keeping the ratio of the linear speed of the surface of the first sleeve 33 to the linear speed of the surface of the photosensitive drum 28Y to a degree between 1.0 times or more and 1.2 times or less, it becomes advantageous in view of toner deterioration. On the other hand, there is a concern of lowering in developing performance by a supplying amount of the toner to the photosensitive drum 28Y being reduced, however, in the present Embodiment, the two developing rollers 30 and 31 are provided, so that it is possible to maintain the toner supplying amount to the photosensitive drum 28Y even when the linear speed ratio is lowered.

The first magnet 36 is disposed inside the first sleeve 33, and as shown in FIG. 3, includes a plurality of magnetic poles 101 through 107. Between an inner periphery of the first sleeve 33 and an outer periphery of the first magnet 36, a space which allows rotation of the first sleeve 33 is provided.

The developer attracted onto the first sleeve 33 is fed, by rotation operation of the first sleeve 33, toward the photosensitive drum 28Y, and develops the latent image formed on the photosensitive drum 28Y. After developing the latent image formed on the photosensitive drum 28Y, the developer on the first sleeve 33 is fed, by the rotation operation of the first sleeve 33, to a vicinity of the second developing roller 31. And in a vicinity of a closest position between the first developing roller 30 and the second developing roller 31, by a magnetic field generated by the first magnet 36 included in the first developing roller 30 and the second magnet 37 included in the second developing roller 31, the developer is delivered from the first sleeve 33 onto the second sleeve 34. Incidentally, the first sleeve 33 and the second sleeve 34 are disposed with a gap of 3 mm at the closest portion.

The second developing roller 31 is a developer carrying member which is rotationally driven, is disposed downstream of the first developing roller 30 with respect to the rotational direction of the photosensitive drum 28Y and so as a rotational center R2 of the second developing roller 31 to be above a rotational center R1 of the first developing roller 30 with respect to a vertical direction, and the developer is delivered from the first developing roller 30 thereto by magnetic force (FIG. 2). In the present Embodiment, the entire second developing roller 31 is positioned above the rotational center R1 of the first developing roller 30. The second developing roller 31 is disposed, similar to the first developing roller 30, at a position adjacent to the photosensitive drum 28Y, so as a rotational axis thereof to be approximately parallel to the rotational axis of the photosensitive drum 28Y. Therefore, between the second developing roller 31 and the first developing roller 30, the rotational axes thereof are approximately parallel to each other.

Such second developing roller 31 includes a rotatable second sleeve 34 (developing sleeve, second developing sleeve) 34 and the second magnet (developing magnet, second developing magnet, fixed magnet) 37, which is disposed non-rotatably inside the second sleeve 34 and attracts the developer to a surface of the second sleeve 34 with magnetic force thereof. And to the second developing roller 31, according to the magnetic force thereof, the developer is delivered from the first developing roller 30 (first sleeve 33) and attracted (carried), and develops the electrostatic latent image formed on the rotating photosensitive drum 28Y with the developer. Incidentally, on a side of the second developing roller 31, the separating roller 32, which will be described below, is positioned.

The second sleeve 34 is a non-magnetic cylindrical member having an outer diameter of 25 mm (radius r2=12.5 mm), and is rotationally driven about a rotation shaft 40. A rotational direction of the second sleeve 34 is, as indicated by an arrow in FIG. 2, clockwise as same as that of the first sleeve 33, and in the present Embodiment, is an opposite direction to the rotational direction of the photosensitive drum 28Y. Therefore, the second sleeve 34 and the photosensitive drum 28Y are rotated in the same direction at a position where each is opposite to the other. In addition, the second sleeve 34 and the first sleeve 33 are rotated in an opposite direction at a position where each is opposite to the other. In the present Embodiment, it is configured so as a linear speed of the surface of the second sleeve 34 to be 1.2 times (=780 mm/s) relative to the linear speed of the surface of the photosensitive drum 28Y. The second magnet 37 is disposed inside the second sleeve 34, and as shown in FIG. 4, includes a plurality of magnetic poles 201 through 207. Between an inner periphery of the second sleeve 34 and an outer periphery of the second magnet 37, a space which allows rotation of the second sleeve 34 is provided.

The developer attracted onto the second sleeve 34 is fed, by rotation operation of the second sleeve 34, toward the photosensitive drum 28Y, and develops the electrostatic latent image formed on the photosensitive drum 28Y. After developing the electrostatic latent image formed on the photosensitive drum 28Y, the developer remaining on the second sleeve 34 is conveyed, by the rotation operation of the second sleeve 34, to a vicinity of the separating roller 32. And in a vicinity of a closest position between the second developing roller 31 and the separating roller 32, by a magnetic field generated by the second magnet 37 included in the second developing roller 31 and the third magnet 38 included in the separating roller 32, the developer is delivered from the second sleeve 34 to a third sleeve 35 of the separating roller 32.

The separating roller (collecting roller) 32 as a separating portion, is disposed on an opposite side to the photosensitive drum 28Y with respect to a rotational center of the second sleeve 34 (the rotational center R2 of the second developing roller 31), and separates the developer, which remains after developing the electrostatic latent image on the photosensitive drum 28Y with the second developing roller 31, from the second developing roller 31. Specifically, the separating roller 32 is a developer carrying member which is rotationally driven, and is disposed, between the second developing roller 31 and the developer collecting screw 44, so as a rotational center thereof (R3) to be above the rotational center R2 of the second developing roller 31.

In addition, the separating roller 32 is disposed so that a rotational axis thereof is approximately parallel to the rotational axis of the second developing roller 31. Such separating roller 32 includes a rotatable third sleeve (separating sleeve) 35 and the third magnet (separating magnet, fixed magnet) 38, which is disposed non-rotatably inside the third sleeve 35 and attracts the developer to a surface of the third sleeve 35 with magnetic force thereof, and is configured so as the developer to be delivered thereto from the second developing roller 31 according to the magnetic force thereof.

The third sleeve 35 is a non-magnetic cylindrical member having an outer diameter of 18 mm (radius of 9 mm), and is rotationally driven about a rotation shaft 41. A rotational direction of the third sleeve 35 is, as indicated by an arrow in FIG. 2, counterclockwise, and in the present Embodiment, is an opposite direction to the rotational direction of the second sleeve 34. Therefore, the third sleeve 35 and the second sleeve 34 are rotated in the same direction at a position where each is opposite to the other. In the present Embodiment, it is configured so as a linear speed of the surface of the third sleeve 35 to be 1.4 times (=910 mm/s) relative to the linear speed of the surface of the photosensitive drum 28Y.

The third magnet 38 is disposed inside the third sleeve 35, and as shown in FIG. 5, includes a plurality of magnetic poles 301 through 305. Between an inner periphery of the third sleeve 35 and an outer periphery of the third magnet 38, a space which allows rotation of the third sleeve 35 is provided.

The developer attracted onto the third sleeve 35 is conveyed, by rotation operation of the third sleeve 35, to a downstream side in the rotational direction of the third sleeve 35, and at a position close to the developer collecting screw 44, by the third magnet 38 involved in the separating roller 32, is separated from the third sleeve 35, and falls off toward a guide member 45 positioned below in the vertical direction by own weight thereof. And the developer which has fallen to the guide member 45 is guided by the own weight thereof toward the developer collecting screw 44.

The guide member 45 and the developer collecting screw 44 constitute a developer collecting portion 47 as a collecting portion which collects the developer separated from the third sleeve 35 on the separating roller 32. In the developer collecting portion 47, the developer collecting screw 44 is disposed so as a rotational center thereof to be positioned, with respect to the vertical direction, above the rotational center R2 of the second developing roller 31 and below the rotational center R3 of the separating roller 32, and feeds the developer delivered (collected) from the separating roller 32 while stirring.

The guide member 45 as a guiding portion is disposed below the separating roller 32 in the vertical direction and so as a closest position P2 between the guide member 45 and the separating roller 32 to be above the rotational center R2 of the second developing roller 31 in the vertical direction, and guides the developer separated by the separating roller 32 toward the developer collecting screw 44. Such guide member 45 includes, in order for the separated developer to be more reliably guided toward the developer collecting screw 44, a slope 45a on which the developer slides down by the own weight thereof. The slope 45a is sloped with respect to a horizontal direction so as the developer collecting screw 44 side to be lower than a lower position of the separating roller 32.

The developer collecting screw 44 as a collecting screw collects the developer separated from the separating roller 32, and feeds the collected developer to a developer circulating portion 46, which will be described next. In other words, the developer collecting screw 44 is a screw feeding member used to feed the developer, which has slid down on the slope of the guide member 45 and been collected, in one direction while stirring.

The developer circulating portion 46 is a supplying portion which supplies the developer to the first developing roller 30, and the developer circulating portion 46 includes a regulating member 50, the developer supplying screw 42 and the developer stirring screw 43. In the developer circulating portion 46, the developer is fed approximately in the horizontal direction while being stirred in the developer supplying screw (supplying screw) 42 and the developer stirring screw (stirring screw) 43, and is supplied to the first developing roller 30. In addition, as described above, the developer collected by the developer collecting portion 47 falls by the own weight thereof and is guided into the developer circulating portion 46.

The developer supplying screw 42, the developer stirring screw 43 and the developer collecting screw 44 are screw feeding members which feed the developer in one direction while stirring, and the developer supplying screw 42 and the developer stirring screw 43 are positioned below the developer collecting screw 44 in the vertical direction. In addition, these developer supplying screw 42, developer stirring screw 43 and developer collecting screw 44 are disposed so as rotational axes thereof to be approximately parallel to each other. The rotational axis of each of these screws is also approximately parallel to the rotational axis of the first developing roller 30.

The developer supplying screw 42 as a supplying screw is positioned between the first developing roller 30 and the developer stirring screw 43, and between the developer stirring screw 43 and the developer supplying screw 42, a partitioning wall 48 of the developing container 70 is disposed. The partitioning wall 48 of the developing container 70 is disposed with extending along the rotational axis direction of the developer supplying screw 42 and the developer stirring screw 43. To the partitioning wall 48, communicating openings (communicating portion, not shown) which communicate a first feeding path (first chamber) 71, in which the developer is fed by the developer supplying screw 42, with a second feeding path (second chamber) 72, in which the developer is fed by the developer stirring screw 43, are provided. In other words, the developer supplying screw 42 is disposed in the first feeding path 71, and the developer stirring screw 43 is disposed in the second feeding path 72. And between the first feeding path 71 and the second feeding path 72, the partitioning wall 48 is disposed, and a circulating path of the developer is formed by the first feeding path 71 and the second feeding path 72.

The developer stirred by the developer collecting screw 44 falls, through a communicating opening (not shown) formed in a dividing wall 73 of the developing container 70 disposed between the developer collecting screw 44 and the developer supplying screw 42, by the own weight thereof toward the developer supplying screw 42. Incidentally, the guide member 45 described above is integrally formed with the dividing wall 73, and the developer collecting screw 44 is disposed above the dividing wall 73.

A position of the communicating opening, through which the developer stirred by the developer collecting screw 44 falls by the own weight thereof and is guided into the developer circulating portion 46, is preferably disposed with avoiding an area in which the developer is being supplied toward the first developing roller 30 (an intermediate portion with respect to the rotational axis direction of the developer supplying screw 42). In the present Embodiment, the position of the communicating opening is set at a position included in a range of a downstream end portion (terminal portion) in a developer feeding direction in the first feeding path 71 in which the developer supplying screw 42 is disposed.

The developer feeding directions of the developer supplying screw 42 and the developer stirring screw 43 are opposite directions to each other. And an starting end side (upstream end side in the developer feeding direction) and the terminal end side (downstream end side in the developer feeding direction) of the first feeding path 71, in which the developer supplying screw 42 is disposed, and a terminal end side and a starting side of the second feeding path 72, in which the developer stirring screw 43 is disposed, communicate via communicating openings provided in the partitioning wall 48. Therefore, the developer is circulated in the rotational directions of the developer supplying screw 42 and the developer stirring screw 43, which are indicated by the arrows in FIG. 2, and in the approximately horizontal direction in the developing container 70, and a portion thereof is supplied toward the first developing roller 30.

A developer replenishing port 51 (see FIG. 2) is disposed above the developer stirring screw 43 in the developing container 70, and is coupled to the developer storing portion 27Y (see FIG. 1). And the developer replenishing port 51 is configured so as the developer accommodated in the bottle mounted to the developer storing portion 27Y to be able to be replenished to the second feeding path 72, in which the developer stirring screw 43 is disposed.

As described above, since the toner weight ratio of the developer accommodated in the bottle of the developer storing portion 27Y is greater than the toner weight ratio of the developer in the developing device 1Y, it is possible to keep the toner weight ratio of the developer in the developing device 1 constant by adjusting the developer replenished to the developer stirring screw 43.

A toner density detecting sensor 49 (see FIG. 2) is disposed to detect toner density in the developer contained in the developer circulating portion 46. The toner density detecting sensor 49 is a sensor which detects magnetic permeability of the developer. The toner density is utilized, in order to correspond to the consumed amount of the toner in the developing device 1Y, for control of the developer replenishment from the developer storing portion 27Y. For example, when it is detected that the toner density is decreased below a predetermined value, the developer is replenished from the developer storing portion 27Y. Incidentally, since the magnetic permeability of the developer varies depending on the toner density, it is possible to detect the toner density using the magnetic permeability.

The regulating member 50 is disposed adjacent to the first developing roller 30, and is used to regulate the amount of the developer supplied from the developer circulating portion 46 to the first developing roller 30. It is possible to configure the regulating member 50 so as to regulate, for example, based on a gap between the surface of the first developing sleeve 33 of the first developing roller 30 and an end portion of the regulating member 50, the amount of the developer attracted to the first developing roller 30.

The developer in the circulating path in the developing container 70 is fed in the approximately horizontal direction while being stirred in the developer circulating portion 46, then supplied to the first developing roller 30, and delivered from the first developing roller 30 to the second developing roller 31 disposed above according to the magnetic force. Next, after being delivered again according to the magnetic force from the second developing roller 31 to the separating roller 32 disposed on the side surface of the second developing roller 31, the developer is separated from the separating roller 32 by the third magnet 38 included in the separating roller 32, and furthermore, is collected to the developer collecting portion 47 and guided again into the developer circulating portion 46.

### [on the Developer]

As described above, in the present Embodiment, the two-component development type is used as a development type, and for the developer, developer in which non-magnetic toner having negative charging polarity and a magnetic carrier are mixed is used. In this case, the non-magnetic toner is charged to negative due to triboelectric charging with the magnetic carrier, and the magnetic carrier is charged to positive. The non-magnetic toner is toner in which to resin such as polyester and acrylic styrene, colorants, wax components, etc. are included, the resin is processed to be powder through pulverization or polymerization, and fine powder such as titanium oxide and silica are added to a surface of the resin. The magnetic carrier is a carrier in which to a surface layer of a core constituted by resin particles mixed with ferrite particles and magnetic powder, a resin coat is applied. The toner density in the developer (weight ratio of the toner contained in the developer) in an initial state is, in the present Embodiment, 8%.

Incidentally, it is preferable that the magnetic carrier have, in an applied magnetic field of 1000 oersteds (79577 A/m), a magnetized amount per unit mass of 40 A m²/kg or more and 80 A m²/kg or less. By reducing the magnetized amount of the magnetic carrier, an effect of suppressing scavenging by a magnetic brush is obtained, however, it makes difficult for the magnetic carrier to be adhered to the non-magnetic sleeve by the magnet inside the developing roller, which may cause image defect such as adhesion of the magnetic carrier to the photosensitive drum to occur. Incidentally, the scavenging is a phenomenon in which, by the magnetic carrier which once has completed the development, the developed toner or the toner being used for the development is scraped off. In addition, if the magnetized amount of the magnetic carrier is more than the range described above, image defect may occur due to pressure of the magnetic brush as described above. In the present Embodiment, a magnetic carrier of which the magnetized amount per unit mass is 63 A m²/kg is used.

The magnetized amount of the magnetic carrier is measured by using a magnetic property automatic recording device of an oscillating magnetic field type BHV-30 manufactured by Riken Denshi Co., Ltd. The magnetic property value of the magnetic carrier is determined by generating an external magnetic field of 1000 oersteds and measuring a strength of magnetization at that time. The magnetic carrier is set into a state of being packed so as to be dense enough in a plastic container having a cylindrical shape. Magnetized moment is measured in this state, an actual weight when a sample is put is measured, and the strength of magnetization (A m²/kg) is determined.

A true specific gravity of the magnetic carrier is determined by using an automatic density measurer of dry-process type AccuPyc 1330 manufactured by Shimadzu Corporation. In the present Embodiment, a magnetic carrier of which the true specific gravity (density) is 4.6 (g/cm³) is used. In addition, a magnetic carrier of which a weight mean diameter is 35 μm (radius b=17.5 μm) is used.

In general, the two-component development type using toner and a carrier has characteristics that, since both are charged to a predetermined polarity by bringing the toner and the carrier into frictional contact, stress to which the toner is subjected is less than a one-component development type using a one-component developer. On the other hand, through a use for a long period of time, contamination (spent) adhered to the surface of the carrier is increased, so that an ability thereof to charge the toner is gradually decreased. As a result, a problem such as fogging and toner scattering occurs. In order to extend a lifetime of a two-component developing device, it is conceivable to increase an amount of the carrier accommodated in the developing device, however, since this leads to an increase in a size of the developing device, it is undesirable.

In order to solve the problem described above according to the two-component developer, in the present Embodiment, an ACR (Auto Carrier Refresh) type is employed. The ACR type is a type which suppresses, by gradually replenishing new developer from the developer storing portion 27Y into the developing device 1Y and gradually discharging the developer, of which the charging performance is deteriorated, from a discharging port (not shown) in the developing device 1Y, an increase of the deteriorated carriers. By this, it becomes possible to gradually replace the deteriorated carriers in the developing device 1Y with new carriers, and maintain the charging performance of the carriers in the developing device 1Y approximately constant.

### [on the Magnetic Poles of Each Magnet]

Next, the magnetic pole configurations of the first magnet 36, the second magnet 37 and the third magnet 38 included in the first developing roller 30, the second developing roller 31 and the separating roller 32 shown in FIG. 3, FIG. 4 and FIG. 5 will be described.

As shown in FIG. 3, the first magnet 36 included in the first developing roller 30 is configured to have the magnetic pole configuration of seven poles including the plurality of the magnetic poles 101, 102, 103, 104, 105, 106 and 107. The magnetic pole 106 among these is a delivery pole for delivering the developer from the first developing roller 30 to the second developing roller 31. The magnetic poles 101 through 107 are disposed in this numerical order in the rotational direction of the first sleeve 33. The magnetic pole 101 is an S pole, disposed at a position opposite to the regulating member 50 across the first sleeve 33, and is a magnetic pole for adjusting the amount of the developer conveyed on the first sleeve 33 as described above. The magnetic pole 104 is an N pole, disposed at a position opposite to the photosensitive drum 28Y across the first sleeve 33, and is a magnetic pole for developing the electrostatic latent image formed on the photosensitive drum 28Y.

The magnetic pole 106 as the delivery pole is an N pole, is a magnetic pole for delivering the developer from the first sleeve 33 to the second sleeve 34 according to the magnetic field generated in collaboration with the second magnet 37 of the second developing roller 31, and hereinafter, the magnetic pole 106 may be referred to as a delivery pole 106. The magnet pole 107 is an N pole, and is used to attract the developer supplied from the developer supplying screw 42 onto the first sleeve 33. The magnetic poles 102, 103 and 105 are an N pole, an S pole and an S pole, respectively, and as the first sleeve 33 is rotated, are used as conveying poles to convey the developer attracted by the magnetic pole 107 above.

In addition, the magnetic pole 107 is disposed on a downstream side of the delivery pole 106 with respect to the rotational direction of the first sleeve 33, and is the same pole as the delivery pole 106. The delivery pole 106 and the magnetic pole 107 form, with a repulsive magnetic field generated in collaboration therebetween, a low magnetic force portion 110, of which magnetic force is lower than that of the delivery pole 106. By this low magnetic force portion 110, the developer is peeled off from the first sleeve 33, and the delivery of the developer from the first sleeve 33 to the second sleeve 34 is promoted. Incidentally, the low magnetic force portion 110 has approximately no magnetic force in the present Embodiment, however, may have a low magnetic force and the low magnetic force portion may be, for example, a magnetic pole of which magnetic force (normal component of magnetic flux density Br) is 5 mT or less. This also applies to a low magnetic force portion 210 of the second magnet 37 shown in FIG. 4 and a low magnetic force portion 310 of the third magnet 38 shown in FIG. 5.

As shown in FIG. 4, the second magnet 37 included in the second developing roller 31 is configured to have the magnetic pole configuration of seven poles including the plurality of the magnetic poles 201, 202, 203, 204, 205, 206 and 207. The magnet pole 201 among these is a receiving pole for the second developing roller 31 to receive the developer from the first developing roller 30. The magnetic poles 201 through 207 are disposed in this numerical order in the rotational direction of the second sleeve 34.

The magnetic pole 201 as the receiving pole is a magnetic pole for attracting, according to the magnetic field generated in collaboration with the magnetic pole 106 of the first magnet 36 of the first developing roller 30, the developer from the first sleeve 33 to the second sleeve 34, and hereinafter, the magnetic pole 201 may be referred to as a receiving pole 201. The magnetic pole 207 is a magnetic pole which delivers the developer from the second sleeve 34 to the third sleeve 35 according to the magnetic field generated in collaboration with the third magnet 38 of the separating roller 32.

In addition, the receiving pole 201 is an S pole, which is opposite pole to the delivery pole 106, and as described above, is used to attract the developer from the first developing roller 30 (first sleeve 33) onto the second sleeve 34. The magnetic pole 203 is an S pole, disposed at a position opposite to the photosensitive drum 28Y across the second sleeve 34, and is a magnetic pole for developing the electrostatic latent image formed on the photosensitive drum 28Y.

The magnetic poles 202, 204, 205 and 206 are an N pole, an N pole, an S pole and an N pole, respectively, and as the second sleeve 34 is rotated, are used to convey the developer attracted by the magnetic pole 201 above. The magnetic pole 207 is an S pole, and delivers the developer, which has passed a developing area with the photosensitive drum 28Y corresponding to the magnetic pole 203, according to a magnetic field generated in collaboration with the magnetic pole 303 in the third magnet 38 included in the separating roller 32, from the second sleeve 34 to the third sleeve 35, which is opposite to the second sleeve 34.

In addition, the magnetic pole 207 is disposed on an upstream side of the receiving pole 201 with respect to the rotational direction of the second sleeve 34, and is the same pole as the receiving pole 201. The receiving pole 201 and the magnetic pole 207 form, with a repulsive magnetic field generated in collaboration therebetween, the low magnetic force portion 210, of which magnetic force is lower than that of the magnetic pole 207. By this low magnetic force portion 210, the developer is peeled off from the second sleeve 34, and the delivery of the developer from the first sleeve 33 to the second sleeve 34 is promoted. In addition, by the low magnetic force portion 210, it becomes possible to prevent the developer from being attracted to a closest portion between the first sleeve 33 and the second sleeve 34, and suppress pressure applied to the developer.

As shown in FIG. 5, the third magnet 38 included in the separating roller 32 includes the plurality of magnetic poles 301, 302, 303, 304 and 305. The magnetic poles 301 through 305 are disposed in this numerical order in the rotational direction of the third sleeve 35.

The magnetic pole 303 is an N pole, which is opposite to the magnetic pole 207, and as described above, is used to attract the developer separated from the second sleeve 34 to the third sleeve 35. The magnetic poles 301, 302 and 304 are an N pole, an S pole and an S pole, respectively, and are used to convey, as the third sleeve 35 is rotated, the developer on the third sleeve 35. In particular, the magnetic pole 304 is used to convey, as the third sleeve 35 is rotated, the developer attracted by the magnetic pole 303 below. The magnetic pole 305 is an N pole, and is a separating pole which is used for separating, with a repulsive magnetic field generated in collaboration with the magnetic pole 301 which has the same pole, the developer which is being attracted to the third sleeve 35 from the third sleeve 35.

### [on a Driving System of the Developing Device]

Next, a driving system for each developing roller and each developer screw in the developing device 1Y will be described. FIG. 6 is an outline view of the driving system of the developing device 1Y. In the present Embodiment, as described above, the linear speed of the surface of the photosensitive drum 28Y is 650 mm/s, and in order to correspond this, it is necessary for each developing roller and each developer screw to be rotationally driven at a high speed. As each developing roller and each developer screw are rotationally driven, the developer is moved and fed. When it becomes a higher speed in particular, it is likely for a balance between a developer amount returning from the developing roller after the development and a supplying amount to the developing roller to be unbalanced. Therefore, in the present Embodiment, as described above, by providing the separating roller 32 which collects the developer from the second developing roller 31, a feeding amount of the developer returning from the second developing roller 31 is adjusted, and the developer amount in the developing container 70 and a height of a developer surface is stabilized.

In the present Embodiment, since there are the plurality of the developing rollers of the first developing roller 30 and the second developing roller 31, and since there are the separating roller 32 and the developer collecting screw 44, accurate circulation and feeding of the developer are required. Therefore, in the present Embodiment, it is configured that a driving motor M1, which rotationally drives a developing roller and collecting roller system, and a driving motor M2, which rotationally drives a screw which stirs and supplies the developer, are provided, and moving speeds of the developer can be independently controlled by each driving motor. In other words, the driving motor M1 as a first driving portion drives the first sleeve 33 of the first developing roller 30, the second sleeve 34 of the second developing roller 31, the third sleeve 35 of the separating roller 32 and the developer collecting screw 44, which are disposed in an area enclosed by a dash-dotted line in FIG. 6. In addition, the driving motor M2 as a second driving portion drives the developer supplying screw 42 and the developer stirring screw 43, which are disposed in an area enclosed by a broken line in FIG. 6.

Each of the driving motors M1 and M2 rotates each developing roller and each developer screw via a transmission mechanism such as a gear and a belt. In addition, settings for the driving motors M1 and M2, which determine the moving and feeding speeds of the developer, are controlled by the controller 500. In other words, the controller 500 independently controls the driving motors M1 and M2, respectively.

In this manner, by configuration that not only the first developing roller 30 and the second developing roller 31 but also the separating roller 32 and the developer collecting screw 44 can be driven by the single driving motor M1, it becomes possible to keep the developer amount constant within a range to which the drive of the driving motor M1 is transmitted. In other words, by rotationally controlling each of these rollers and screws independently from the developer stirring screw 43 and the developer supplying screw 42, the developer remaining after being used for the development of the electrostatic latent image in the first developing roller 30 and the second developing roller 31 is collected by the separating roller 32, with a space of the developer collecting screw 44 as a buffer, it becomes possible to keep the developer amount constant within the range to which the drive of the driving motor M1 is transmitted.

Since the separating roller 32, which collects the developer from the second developing roller 31, and the developer collecting screw 44 are interrelatedly driven by the driving motor M1, it becomes possible to collect the developer without causing the developer to stay between the second developing roller 31 and the separating roller 32. Similarly, since the separating roller 32 and the developer collecting screw 44 are also interrelatedly driven by the driving motor M1, it becomes possible to feed the developer collected from the separating roller 32 with the developer collecting screw 44 without causing the developer to stay.

In addition, by providing the plurality of the driving motors in this manner, it becomes possible to adjust, so as to keep the developer amount in the developer supplying screw 42 and the developer stirring screw 43 constant regardless of the conditions on the developing roller side, the rotational drive of the developer supplying screw 42 and the developer stirring screw 43 independently from the developing roller side. Supposing a case of a configuration in which the developer collecting screw 44 and the separating roller 32 are driven in interrelation with the driving motor M2, since the collected developer is returned to the developer supplying screw 42 and the developer stirring screw 43, it is impossible to keep the developer constant.

Therefore, the driving motor M2 for driving only the developer supplying screw 42 and the developer stirring screw 43, which are disposed on the developer circulating and feeding path side, where it is mostly desired to keep the balance of the developer constant, is separately provided from the driving motor M1 on the developing roller side. By this, even if bulk density and/or flowability of the developer changes along with the use of the image forming apparatus, it becomes possible to keep the developer amount on the developer supplying screw 42 side constant, and supply the developer stably to the first developing roller 30. In addition, by the developer amount at a portion of the toner density detecting sensor 49, which is installed on the developer stirring screw 43 side, also being stabilized, it becomes possible to prevent false detection by the toner density detecting sensor 49.

### [on Suppression of Defect Caused by the Deteriorated Developer]

Next, suppression of defect which occurs when the developer is deteriorated will be described. When the image formation is repeated over a long period of time, the developer may experience cases such as the contamination (spent) is adhered to the carrier as described above, and by the fine powder such as titanium oxide and silica added to the surface of the toner being liberated, an amount of the fine powder on the surface of the toner is changed, so that the chargeability and flowability of the toner may deviate from an appropriate range.

If the chargeability and/or the flowability of the toner deviates from the appropriate range, it becomes likely for fogging, in which the toner is adhered to a blank portion, toner scattering, uneven density, a streak, etc. to occur in a product. The uneven density and the streak occur when an aggregated lump of the developer is formed in the developing container 70 and the developer amount supplied onto each developing roller becomes uneven in a longitudinal direction (the rotational axis direction of the developing roller) by the aggregated lump.

In the present Embodiment, in order to suppress the defect described above such as the toner scattering, the uneven density and the streak upon the developer being deteriorated, the following mechanism is provided. One of that mechanism is a suction cleaning technology, which sucks scattering toner and is provided in a vicinity of the developing roller, and the other is a vibration applying technology, which applies vibration to the developing container 70 in order to efficiently collect the aggregated lump and scattered toner formed in the developing container 70. In other words, in the present Embodiment, as shown in FIG. 2, an air sucking device 65 as a sucking portion which sucks the scattering developer in the developing container 70, and a vibration applying device 501 which applies vibration to the developing device 1Y are provided.

### [Suction Cleaning Technology]

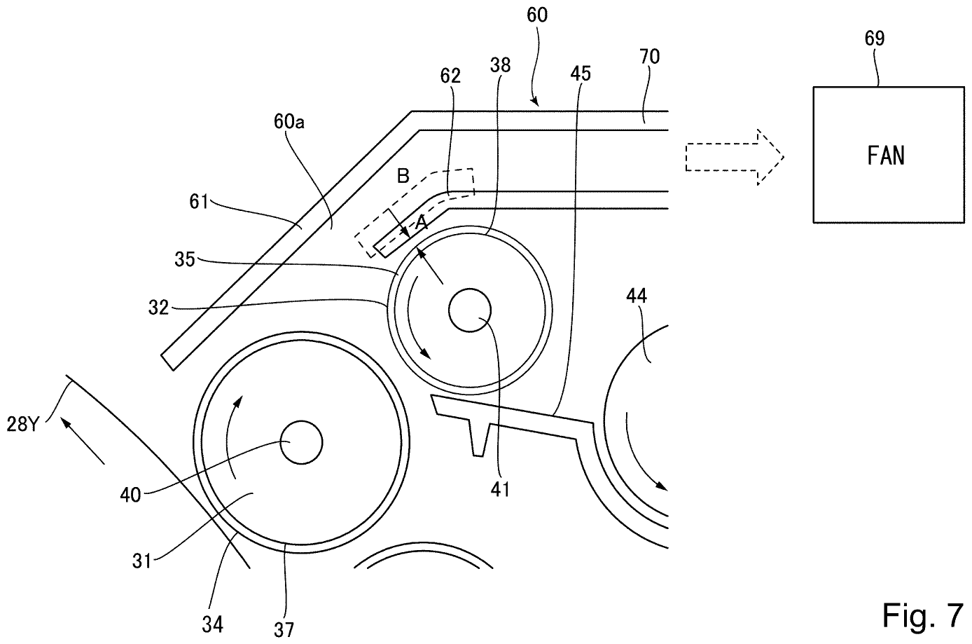

First, the suction cleaning technology will be described using FIG. 2 and FIG. 7. FIG. 7 is a cross-sectional view describing dispositions of the second developing roller 31, the separating roller 32, and a duct 60. The air sucking device 65 is provided with the duct 60, which includes a first duct wall (outside wall) 61 and a second duct wall (inside wall) 62, and a fan 69. In the duct 60, a suction opening 60a which sucks the scattering developer in the developing container 70 is positioned above an opposite portion in which the second sleeve 34 and the third sleeve 35 is opposite to each other. And the fan 69 sucks air through the suction opening 60a via the duct 60.

The second duct wall 62 covers a portion of an inner space of the developing container 70, in which the first and second developing rollers 30 and 31 and the separating roller 32 are disposed and the developer is stored, and suppresses the scattering of the developer from the inner space to an outside thereof. The second duct wall 62 covers an upper portion of the inner space of the developing container 70, however, above the second developing roller 31, the suction opening 60a of the duct 60, which is constituted by the second duct wall 62 and the first duct wall 61 disposed on further outside, is provided.

An end portion on an opposite side to the suction opening 60a of the duct 60 is, with ducts of the developing devices of each color being merged, connected to the fan 69. By sucking air via the duct 60 from the suction opening 60a, it becomes possible to suck and remove the scattering developer upon the development. Upon executing the image forming operation, the fan 69 is activated and the suction and removal of the scattering developer is performed. This suction and removal operation is always performed during image formation.

As shown in FIG. 7, the second duct wall 62 is disposed so as to be along the separating roller 32. Therefore, a sucking path of the duct 60 is provided on an opposite side to the separating roller 32 across the second duct wall 62. In this case, a closest distance A between the separating roller 32 and the second duct wall 62 is set to 1.5 mm in the present Embodiment. Incidentally, this closest distance A preferably be within a range of 0.5 mm or more and 20 mm or less, in view of carrier collection to the duct 60 and the stay of the developer. This is because the wider the closest distance A, the more likely for the carrier to be collected, while the narrower, the more likely for the developer to stay.

### [Vibration Applying Technology]

In an inclined entrance area B of the second duct wall 62 in a vicinity of the suction opening 60a, the scattered toner and the developer accumulate. Therefore, it needs to be cleaned regularly. However, in order for a service representative to clean the second duct wall 62, it is necessary to stop the image forming apparatus for the work, which lowers productivity as an apparatus and usability is low. Thus, the vibration applying technology is used to efficiently collect the developer and the toner accumulated in the inclined entrance area B of the second duct wall 62 in the vicinity of the suction opening 60a.

The vibration applying technology will be described using FIG. 2. The vibration applying device 501 is a device which applies vibration to the developing device 1Y from a back surface side (an opposite side to a side facing the photosensitive drum 28Y). The vibration applied by the vibration applying device 501 is transmitted through the developing container 70, etc. to the regulating member 50, the first developing roller 30, the second developing roller 31, the first duct wall 61, the second duct wall 62, etc., and approximately the entire developing device 1Y is vibrated.

In particular, by applying the vibration in addition to gravity, it becomes possible to cause the developer and the toner accumulated in the inclined entrance area B of the second duct wall 62 in the vicinity of the suction opening 60a to be moved and fall to the separating roller 32 side. In addition, since the vibration from the vibration applying device 501 can be applied to approximately the entire developing device 1Y, it becomes possible to break up the aggregated lump formed in the developer generated due to a long term use. In addition, the vibration from the vibration applying device 501 also has an effect to break up the developer, which has been in a state of stagnation and is generated in gaps between the regulating member 50 and the developer supplying screw 42, between the developer stirring screw 43 and the toner density detecting sensor 49 and/or an inner wall of the developing container 70, between the developer collecting screw 44 and the developing container 70, etc. By this, it becomes possible to suppress not only the defect due to the toner scattering but also the occurrence of the uneven density and the streak.

### [Scattering of the Developer to an Outside]

However, even when the fan 69 is operated and the developer and the toner accumulated in the inclined entrance area B of the second duct wall 62 in the vicinity of the suction opening 60a are moved and falls by the vibration applying device 501, there may be a case in which the developer and the toner cannot be sufficiently sucked and collected. This is because when the developing container 70 is in a positive pressure state, in which a pressure inside the developing container 70 is higher than a pressure outside the developing container 70, the developer and the toner which have been moved and fallen by the vibration applying device 501 are not collected into the developing container 70 nor sucked by the air suction, but are scattered outside the developing device 1Y. To reasons why the developing container 70 becomes the positive pressure state, driving states of each developing roller and each developer screw are related.

Specifically, when both the first developing roller 30, the second developing roller 31, the separating roller 32 and the developer collecting screw 44, which are driven by the driving motor M1, and the developer supplying screw 42 and the developer stirring screw 43, which are driven by the driving motor M2, are driven under the same condition as during image formation, it is likely for the developing container 70 to become the positive pressure state. In other words, when it becomes a state, in which a gap between the first developing roller 30 and the second developing roller 31, a gap between the regulating member 50 and the first developing roller 30, etc., which have gaps connecting the inside and the outside of the developing container 70, are coated by the developer, these gaps are filled with the developer, and it becomes difficult for air in the developing container 70 to escape to the outside. Meanwhile, an air current taken in from the outside of the developing container 70 through the rotational drive of each developing roller and each developer screw and the toner replenishment enters the developing container 70. As a result, the air entering the developing container 70 has no way to escape to the outside, causing the pressure inside the developing container 70 to gradually be increased, and the developing container 70 becomes the positive pressure state in which the pressure inside the developing container 70 is higher than the pressure outside the developing container 70.

When the inside of the developing container 70 becomes the positive pressure state, the developer which is moved and falls by the vibration applying device 501 and the scattered toner do not enter the developing container 70, but are adhered to the photosensitive drum 28Y and/or scattered outside the developing device 1Y and contaminate a periphery of the developing device 1Y.

### [Control of the Driving Motors M1 and M2]

Thus, in the present Embodiment, so as the inside of the developing container 70 not to become the positive pressure state, drive settings for the driving motor M1, which drives the first developing roller 30, the second developing roller 31, the separating roller 32 and the developer collecting screw 44, and the driving motor M2, which drives the developer supplying screw 42 and the developer stirring screw 43, are adjusted. Here, to adjust the driving settings for the driving motors is equivalent to adjust the moving speed of the developer in each developing roller and each developer screw. Since the inside of the developing container 70 often becomes the positive pressure state when the developer is present in the gaps between the first and second developing rollers 30 and 31 and the separating roller 32, etc., in order to eliminate the developer between these rollers, the driving motor M1 and the driving motor M2 are set as follows.

That is, at least at start of a vibration applying operation by the vibration applying device 501, the controller 500 controls the vibration applying device 501 and the driving motors M1 and M2 so as to become a state in which the drive of the driving motor M2 is stopped and the driving motor M1 is driven. When the vibration applying operation by the vibration applying device 501 is started, it is preferable to start the vibration applying operation by the vibration applying device 501 after stopping the drive of the driving motor M2. In addition, in the present Embodiment, while the vibration applying operation is being performed, the controller 500 controls the vibration applying device 501 and the driving motors M1 and M2 so as to become a state in which the drive of the driving motor M2 is stopped and the driving motor M1 is driven.

Specifically, while the controller 500 keeps rotationally driving the driving motor M1, which drives the first and second developing rollers 30 and 31, the separating roller 32, and the developer collecting screw 44, at the same speed as during image formation, the controller 500 turns off (stops) the drive of the driving motor M2, which drives the developer supplying screw 42. When the driving motor M2 is turned off, the rotation of the developer supplying screw 42, which supplies the developer to the first developing roller 30, is stopped, so that the developer amount supplied from the developer supplying screw 42 to the first developing roller 30 becomes zero after several seconds from the stop. Meanwhile, since the driving motor M1 keeps turned on, the developer on the first developing roller 30 is fed to the second developing roller 31 and then delivered to the separating roller 32. Therefore, for the several seconds after changing the settings for the driving motors M1 and M2, the developer amount delivered from the second developing roller 31 to the separating roller 32 is not zero, but then is decreased, and as more time elapses, the developer on the first developing roller 30 and on the second developing roller 31 becomes absent, and the developer amount delivered from the second developing roller 31 to the separating roller 32 also becomes zero.

Upon becoming this state, since the developer between the first developing roller 30 and the second developing roller 31 also becomes absent, gaps appear between each of the rollers. And since there is the gap in the vicinity of the developing rollers, and the developer supplying screw 42 and the developer stirring screw 43 are not driven, there is no factor to increase the pressure inside the developing container 70, so that it becomes unlikely for the developing container 70 to become the positive pressure state.

Upon examining various settings for the driving motors M1 and M2 and the pressure states inside the developing container 70, it is found that it is less likely for the pressure inside the developing container 70 to become the positive pressure when the following condition is met. The condition is, when a total developer amount supplied from the developer supplying screw 42 to the first developing roller 30 during a predetermined time after changing the settings for the driving motors M1 and M2 is defined as A (g), and a developer amount which leaves the second developing roller 31 during a predetermined time after changing the settings for the driving motors M1 and M2 is defined as B (g) (for example, a total developer amount delivered from the second developing roller 31 to the separating roller 32 is defined as B (g)), a case in which the following formula a is satisfied.

The developer supplying amount to the developing roller A<The developer amount which leaves the developing roller B Formula α

Incidentally, the total developer amount delivered from the second developing roller 31 to the separating roller 32 in the predetermined time is defined as B (g), however, the developer amount delivered from the second developing roller 31 to the separating roller 32, the developer amount delivered from the separating roller 32 to the developer collecting screw 44, and the developer amount returning from the developer collecting screw 44 to the developer circulating portion 46 of the developing container 70 are depending on the setting for the same driving motor M1, and thus become approximately the same values. Therefore, the developer amount B described above may not be the developer amount delivered from the second developing roller 31 to the separating roller 32, but may be the developer amount delivered from the separating roller 32 to the developer collecting screw 44, or the developer amount returning from the developer collecting screw 44 to the developer circulating portion 46.

As to the total developer amount A (g) supplied from the developer supplying screw 42 to the first developing roller 30 during the predetermined time, it is measured by bringing the air sucking device 65 to a vicinity of the first developing roller 30 to suck the developer, and the sucked developer amount is used as the developer amount A (g) supplied to the first developing roller 30. As to the developer amount B which leaves the second developing roller 31, the developer on the separating roller 32 side is cleaned in advance, and the collected developer amount by the separating roller 32 in the predetermined time is used as the leaving developer amount B (g).

If the driving is continued while being in the relationship of the formula a described above (the developer supplying amount to the developing roller A<the developer amount which leaves the developing roller B), the developer fed by the first developing roller 30, the second developing roller 31, the separating roller 32 and the developer collecting screw 44 is gradually decreased, and eventually becomes approximately zero. In that state, since the pressure inside the developing container 70 is not positive pressure, when the vibration applying device 501 is operated, it becomes possible to efficiently collect the developer and the toner accumulated in the inclined entrance area B of the second duct wall 62 in the vicinity of the suction opening 60a into the developing container 70, and prevent the scattering.

In addition, by establishing the relationship of the formula a, it becomes possible to move the developer which is nearly stationary during normal image formation in an area in the vicinity of the first developing roller 30 and the regulating member 50. By this, it becomes possible to prevent, by breaking up the lump of the developer which is almost aggregated because of not being moved long period of time and being in the stationary state in the vicinity of the regulating member 50, the occurrence of the defect caused by the aggregated lump formed inside the developing container 70.

As to the settings for the driving motors M1 and M2 which satisfy the relationship of the formula a described above, it is preferable that the settings for the driving motors M1 and M2 be changed before the vibration applying device 501 is operated, and after few seconds, the vibration applying device 501 be operated. Since it is immediately after the vibration applying device 501 is operated that falling and the moving amount of the developer and the toner, which are accumulated in the inclined entrance area B of the second duct wall 62 in the vicinity of the suction opening 60a, is large, it should be set into a state in which the inner pressure inside the developing device 1Y is lowered before the vibration applying device 501 starts the operation. As to a time between the changing of the settings for the driving motors M1 and M2 described above and the start of the operation of the vibration applying device 501, temporal change of the inner pressure inside the developing device 1Y after changing the settings for the driving motors M1 and M2 is monitored, and the time is set based on the temporal change. By setting the time between the changing of the settings for the driving motors M1 and M2 described above and the start of the operation of the vibration applying device 501 as short as possible, it is possible to avoid the lowering in productivity.

If it is a case that after operating the vibration applying device 501, upon observing transition of the fall off and the moving amount of the developer and the toner which are accumulated in the inclined entrance area B of the second duct wall 62 in the vicinity of the suction opening 60a, the fall off and the moving amount of the accumulated developer and toner gets increased after some time has passed since the start of the operation of the vibration applying device 501 more than immediately after the start of the operation of the vibration applying device 501, then it is not necessary to change the settings for the driving motors M1 and M2 before the operation of the vibration applying device 501. What is important is to configure the settings which makes it possible to efficiently collect the developer and the toner into the developing device 1Y, when the developer and the toner, which are accumulated in the inclined entrance area B of the second duct wall 62 in the vicinity of the suction opening 60a, fall off.

Incidentally, regarding the collection of the toner and the scattered toner of the developer upon the vibration applying device 501 being operated, relationship to the driving settings for the driving motor M1, which drives the first developing roller 30, the second developing roller 31, the separating roller 32 and the developer collecting screw 44, and the driving motor M2, which drives the developer supplying screw 42 and the developer stirring screw 43, are verified, and representative results thereof are as following.

As for verification conditions, the image forming apparatus is installed in an environment with a temperature of 28 degrees Celsius and humidity of 85%, and an image, of which image ratio of each color of YMCK is 30%, is continuously output for 50000 sheets. At that time, the vibration applying device 501 is operated every 2000 sheets. As for the driving motors M1 and M2 when the vibration applying device 501 is operated, the verification is performed under four conditions of Nos. 1 through 4 in Table 1.

TABLE 1

| | Driving motor | Driving motor | |
|---|---|---|---|
| No. | M1 | M2 | Scattering |
| 1 | ON | ON | x |
| 2 | OFF | ON | x |
| 3 | OFF | OFF | x |
| 4 | ON | OFF | ∘ |

As to evaluation for the “scattering”, (1) degree of the contamination in the periphery of the developing device due to the scattered toner and developer is evaluated, and (2) after the image forming apparatus is left unoperated for twenty four hours after printing 50000 sheets, a blank image is output for twenty sheets, and whether or not the image defect such as the contamination occurs in the blank images of the twenty sheets are evaluated. As to the degree of the contamination in the periphery of the developing device due to the scattered toner and developer in (1), an adhesive tape manufactured by Nichiban Co., Ltd. is applied to a contaminated location, and if an amount, which cannot be completely removed by the tape, is adhered thereto, the scattering evaluation is marked as “x”. Because the inability for the adhesive tape to completely remove the contamination suggests that, when a number of sheets on which an image is formed is further increased, the contamination may fall off and contaminate inside the apparatus, and/or the contamination may be transferred to other components upon a service representative performs maintenance and cause the defect. As to the contamination in the blank image in (2), the sheet should ideally be output with a texture of a paper, however, there were some cases in which small contamination as if the lump of the toner falls thereto is observed. When such contamination occurs, the scattering evaluation is marked as “x”. If in either (1) or (2), the evaluation result is “x”, the scattering evaluation is marked as “x”, and if any of the evaluation result is not “x”, the scattering evaluation is marked as “◯”, and the results are summarized in Table 1.

Describing details of the results in Table 1, in an experiment No. 1, the driving motors M1 and M2 are turned on. The on condition is the same state as during image formation, and it is a state such that, as described above, the inside of the developing container 70 becomes the positive pressure state and an air current erupts from the inside to the outside of the developing container 70. As a result, the scattered toner and developer which has fallen by the operation of the vibration applying device 501 cannot be collected into the developing container 70, which results in the contamination of the periphery of the developing device. Therefore, the scattering evaluation is marked as “x”. An experiment No. 2 is a condition in which the driving motor M1 is turned off and the driving motor M2 is turned on. Under this condition, the lump of the scattered toner which has fallen by the vibration applying device 501 is adhered onto the second developing roller 31 and/or the photosensitive drum 28Y. As a result, when the image formation is started next, due to the scattered toner which has fallen, an image seeming like contamination appeared on the blank image. Therefore, the scattering evaluation is marked as “x”. In an experiment No. 3, both of the driving motor M1 and the driving motor M2 are turned off. In this case as well, similar to the experiment No. 2, since the image seeming like contamination appeared on the blank image, the scattering evaluation is marked as “x”.

Based on the results in the experiments No. 2 and No. 3, in a case of a state in which the second developing roller 31 is stopped by turning off the driving motor M1, it can be assumed that it is highly likely that by the lump of the scattered toner, which has fallen due to the vibration applying device 501, being adhered onto the second developing roller 31 and/or the photosensitive drum 28Y, it becomes more likely for the defective image to occur.

Finally, an experiment No. 4 is a condition in which, as in the present Embodiment described above, the driving motor M1 is turned on and the driving motor M2 is turned off. In a case of this condition, since the inside of the developing container 70 is no longer in the positive pressure state, it becomes possible to collect the scattered toner and developer, which has fallen due to the operation of the vibration applying device 501, into the developing container 70, so that it becomes less likely for the periphery of the developing device to be contaminated. In addition, even if the lump of the scattered toner and developer, which has fallen due to the operation of the vibration applying device 501, falls onto the second developing roller 31 and/or the photosensitive drum 28Y, since the second developing roller 31 is rotated and the fallen lump of the toner is dispersed while collected, the defective image in the blank image does not occur, and the scattering evaluation is marked as “◯”.

As described above, in the configuration in which each developing roller and each developer collecting screw are independently driven by the driving motor M1, which drives the first developing roller 30, the second developing roller 31, the separating roller 32 and the developer collecting screw 44, and the driving motor M2, which drives the developer supplying screw 42 and the developer stirring screw 43, by configuring the appropriate settings for the driving motors, it becomes possible to suppress the toner scattering from the developing device 1Y.

Incidentally, when the driving motors M1 and M2 are controlled under the condition for the experiment No. 4, the developer on the first developing roller 30 and the second developing roller 31 becomes absent, and it becomes a state in which the developer is accumulated at a place to which the developer is fed from the developer collecting screw 44. Therefore, since the image formation cannot be performed in this state, it is necessary to perform a recovery sequence to restore the developer balance inside the developing container 70, which is suitable for the image formation.

For this reason, in a case in which the image forming operation is executed after the vibration applying operation by the vibration applying device 501 is performed, the controller 500 executes the image forming operation after executing an operation (idle rotation) which drives the driving motors M1 and M2 for a predetermined time without forming the electrostatic latent image on the photosensitive drum 28Y. Specifically, it is configured that the driving motors M1 and M2 are operated under the same driving condition as during normal image formation, and after the idle rotation is performed for about 10 seconds, the image formation is started. By this idle rotation control, the developer balance inside the developing container 70 is restored to the state suitable for the image formation, and it becomes possible to perform the image formation without generating the defective image.

As such sequence for the restoration, instead of immediately turning on the driving motors M1 and M2 under the same conditions as during the normal image formation, it may be configured to gradually increase driving speeds, initially to speeds of 50% of the normal image formation, then to speeds of 70%. For example, upon rotating the driving motor at a high speed under a state in which the chargeability of the developer is low such as a high humidity environment, the developer may be scattered, so that at start of the sequence for the restoration, by the driving motors M1 and M2 being driven at slower speeds than during normal image formation, and by gradually increasing the driving speeds, it becomes possible to suppress such scattering of the developer. In addition, if it is desired to shorten the sequence for the restoration for ten seconds, the driving motors may be driven faster than the speeds during the normal image formation, or the driving motor M1 and the driving motor M2 may be driven with a time difference. It is sufficient for the sequence for the restoration to be set by considering the installed environment of the image forming apparatus, maximum allowable load for the driving motor, etc.

### First Example of Modified Examples

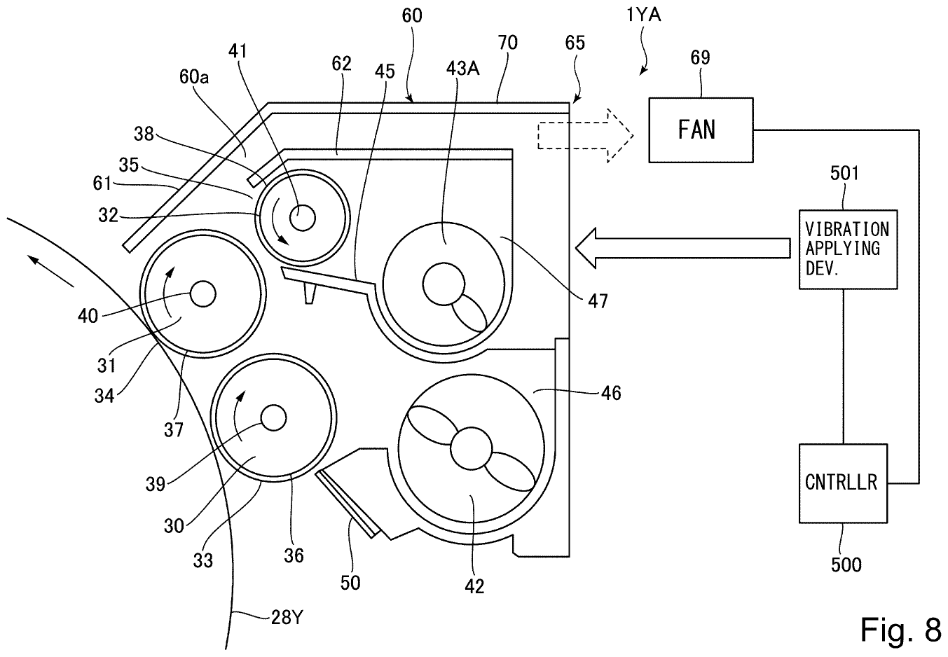

In the present Embodiment, the developing device 1Y as shown in FIG. 2 is described, however, the present Embodiment may also be applied to developing devices having other configurations. For example, FIG. 8 is a cross-sectional view of an outline configuration of a developing device 1YA in a first example of Modified Examples in the present Embodiment. In the developing device 1YA, it is the same that a fan 69 and a vibration applying device 501 are provided thereto as to the developing device 1Y in FIG. 2, however, it is a configuration in which a number of the developer collecting screws is not three but two. That is, in the developing device 1YA, developer is supplied to a first developing roller 30 by a developer supplying screw 42. Thereafter, the developer is delivered to a second developing roller 31, and is moved to a separating roller 32. Thereafter, the developer, which leaves the separating roller 32, is fed by a developer collecting and stirring screw 43A, while being collected and stirred, and is circulated to the developer supplying screw 42. Incidentally, the developer collecting and stirring screw 43A also serves the functions of the developer collecting screw 44 and the developer stirring screw 43 in FIG. 2.

In the developing device 1YA shown in FIG. 8, a driving motor M1 drives the first developing roller 30, the second developing roller 31 and the separating roller 32, and a driving motor M2 drives the developer supplying screw 42 and the developer collecting and stirring screw 43A. And it is configured so that drives of the driving motors M1 and M2 can be independently controlled. In this driving configuration, similar to the present Embodiment described above, by configuring driving settings which satisfy the relationship of the formula a (the developer supplying amount to the developing roller A<the developer amount which leaves the developing roller B), it becomes possible to suppress the occurrence of the defect caused by the toner scattering and/or the aggregated lump. Incidentally, if it is allowable in view of motor load and/or a balance of the developer, the developer collecting and stirring screw 43A may be added to the group of rollers which the driving motor M1 drives.

### Second example of the Modified Examples

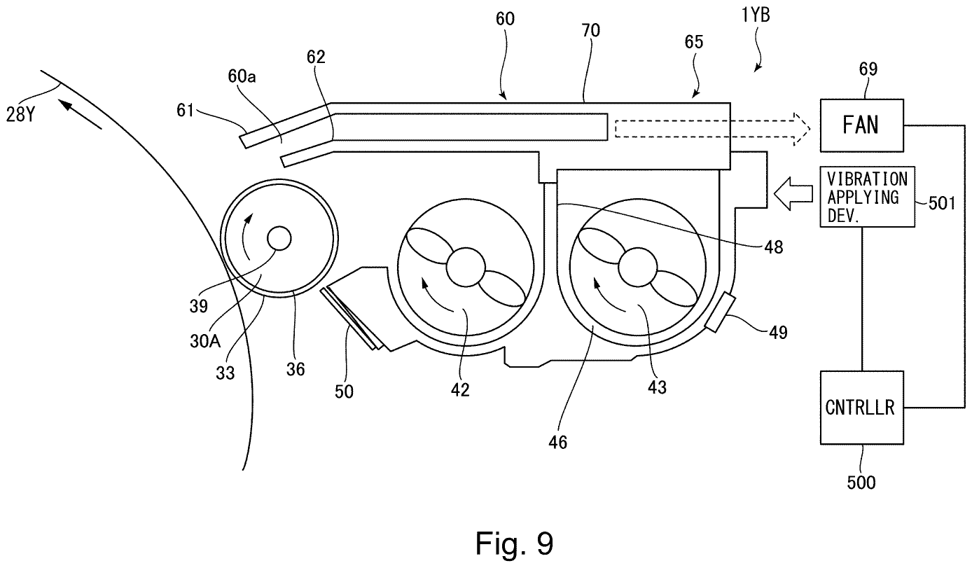

Next, as a second example of the Modified Examples, a developing device 1YB shown in FIG. 9 will be described. FIG. 9 is a cross-sectional view of an outline configuration of the developing device 1YB in the second example of the Modified Examples in the present Embodiment. The developing device 1YB has a configuration in which a single developing roller 30A is provided as a developer carrying member. In addition, the developing device 1YB is provided with a developer supplying screw 42 and a developer stirring screw 43, and developer supplied to the developing roller 30A is returned to the developer supplying screw 42, is fed to the developer stirring screw 43, and is circulated again to the developer supplying screw 42. In other words, compared to the developing device 1Y shown in FIG. 2, it is a configuration in which the second developing roller 31 and the developer collecting screw 44 are omitted.

In the developing device 1YB, a driving motor M1 drives the developing roller 30A, and a driving motor M2 drives the developer supplying screw 42 and the developer stirring screw 43. And it is configured so that drives of the driving motors M1 and M2 can be independently controlled. In this driving configuration, as in the present Embodiment described above, by configuring driving settings which satisfy the relationship of the formula a, it becomes possible to suppress the occurrence of the defect caused by the toner scattering and/or the aggregated lump. [Third example of the Modified Examples]

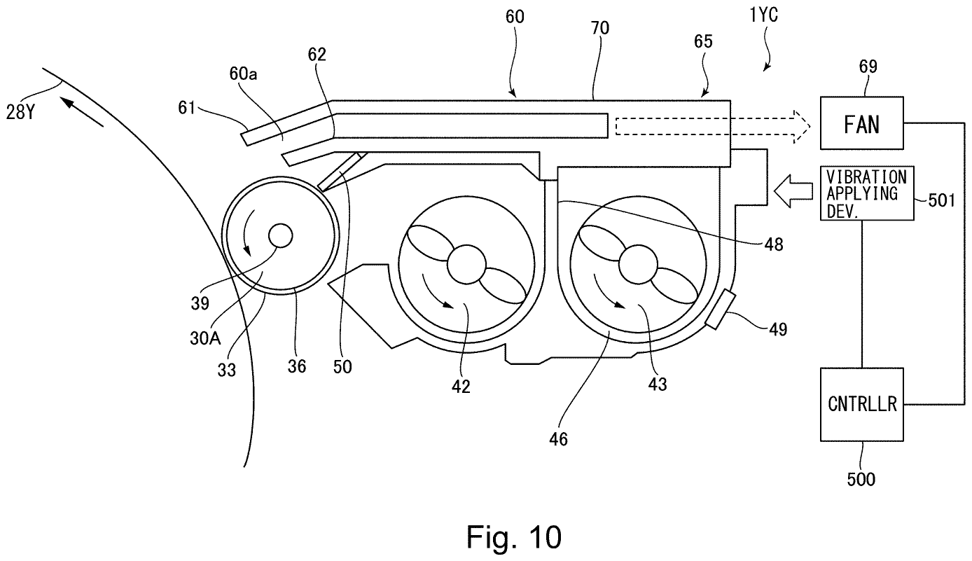

Furthermore, as a third example of the Modified Examples, a developing device 1YC shown in FIG. 10 will be described. FIG. 10 is a cross-sectional view of an outline configuration of the developing device 1YC in the third example of the Modified Examples in the present Embodiment. The developing device 1YC has, similar to the second example of the Modified Examples shown in FIG. 9, a configuration in which a single developing roller 30A is provided as a developer carrying member. However, compared to the second example of the Modified Examples, a position of a regulating member 50 is different, and rotational directions of the developing roller 30A, a developer supplying screw 42 and a developer stirring screw 43 are different. Naturally, since the rotational direction at an opposite position of a photosensitive drum 28Y and the developing roller 30A is different and the position of the regulating member 50 is different, a surface shape of the developing roller 30A, a gap between the regulating member 50 and the developing roller 30A, and a shape such as pitches of the developer supplying screw 42 and the developer stirring screw 43, which determine the feeding speed of the developer, are different from the second example of the Modified Examples shown in FIG. 9 and are optimized. The other configurations and circulation of the developer are the same as in the second example of the Modified Examples.

In the developing device 1YC as well, a driving motor M1 drives the developing roller 30A, and a driving motor M2 drives the developer supplying screw 42 and the developer stirring screw 43. And it is configured so that drives of the driving motors M1 and M2 can be independently controlled. In this driving configuration, as in the present Embodiment described above, by configuring driving settings which satisfy the relationship of the formula a, it becomes possible to suppress the occurrence of the defect caused by the toner scattering and/or the aggregated lump.

### Embodiment 2

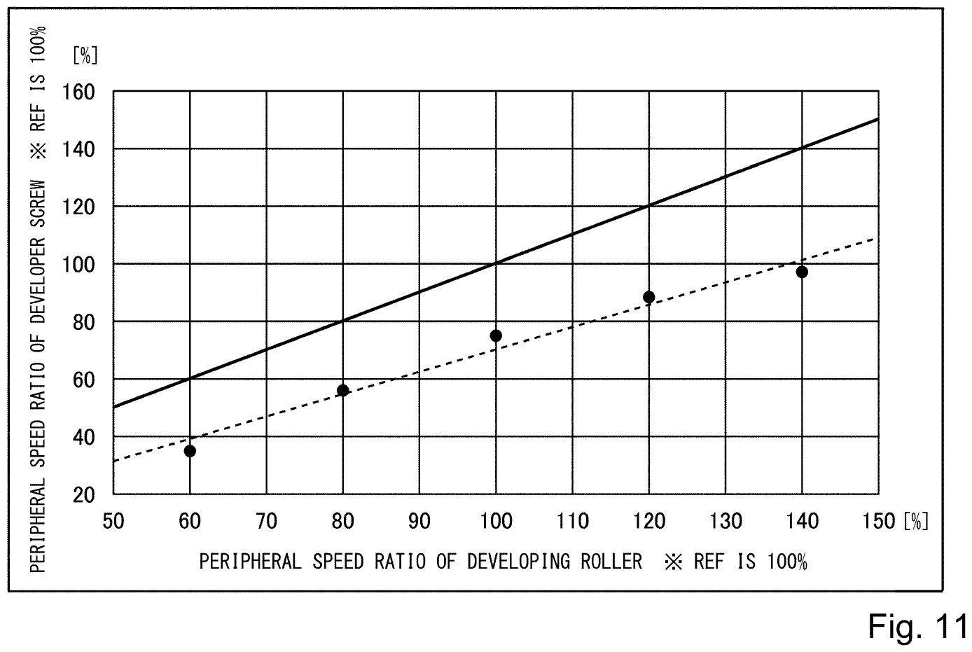

An Embodiment 2 will be described using FIG. 11 while referring to each Figure described above. In the Embodiment 1 described above, the configuration in which, upon performing the vibration applying operation, while the driving motor M1, which drives the first and second developing rollers 30 and 31, the separating roller 32 and the developer collecting screw 44, is kept rotationally driven at the same speed as during image formation, the driving of the driving motor M2, which drives the developer supplying screw 42 and the developer stirring screw 43, is turned off (stopped) is described. In contrast to this, in the present Embodiment, upon performing vibration applying operation, a driving speed of a driving motor M2 is set slower than during image formation. Since the other configurations and actions are the same as those in the Embodiment 1 described above, the same reference numerals will be attached to the same configurations to omit or simplify the description and illustration thereof, and hereinafter, points which differ from those of the Embodiment 1 will be mainly described.

In the case of the Embodiment 1 described above, since the driving of the driving motor M2 is stopped upon the vibration applying operation, the balance of the developer inside the developing device 1Y is unbalanced. As a result, to perform the next image formation, it takes time for the sequence for the restoration for restoring the balance of the developer inside the developing device 1Y, so that the productivity is lowered. Therefore, in the present Embodiment, a case which suppresses the occurrence of the defect caused by the toner scattering and/or the aggregated lump and minimizes the lowering in productivity of the image forming apparatus will be described. Incidentally, in the present Embodiment as well, as in the Embodiment 1, it is configured so that the driving motors for driving each developing roller and each developer screw of the developing device 1Y can be independently controlled.

First, in a case in which the toner scattering may occur, in order to suppress the occurrence of the defect caused by the toner scattering and/or the aggregated lump, driving settings for the developing device 1Y are set to settings which satisfy the formula a (the developer supplying amount to the developing roller A<the developer amount which leaves the developing roller B) described above.

In the Embodiment 1, the driving motor M2 is turned off (stopped), however, there are driving settings which satisfy the formula a described above even without stopping the driving motor M2. In the present Embodiment, at least at start of the vibration applying operation by the vibration applying device 501, the controller 500 controls the vibration applying device 501, the driving motor M1 and the driving motor M2 so as to become a state in which the driving speed of the driving motor M2 is slower than the driving speed during image formation, and the driving speed of the driving motor M1 is approximately the same as during image formation. In this case, at least at the start of the vibration applying operation by the vibration applying device 501, it is preferable that a rotation speed of the developer supplying screw 42 be set to 20% or more slower than the rotation speed of the developer supplying screw 42 during image formation, and more preferably be set to 29% or more slower. In addition, it is preferable that the driving speed of the driving motor M1 in this case be set to the same as during image formation, i.e., to continue the driving speed during image formation, however, for example, it may be increased or decreased by about 5% relative to the driving speed during image formation.

In addition, as in the Embodiment 1, upon starting the vibration applying operation by the vibration applying device 501, it is preferable to start the vibration applying operation by the vibration applying device 501 after making the driving speed of the driving motor M2 be slower than the driving speed during image formation. Furthermore, as in the Embodiment 1, while the vibration applying operation is being performed, the controller 500 controls the vibration applying device 501 and the driving motors M1 and M2 so as to become the state in which the driving speed of the driving motor M2 is slower than the driving speed during image formation, and the driving speed of the driving motor M1 is approximately the same as during image formation.

Here, results of examination in which, while varying the driving speeds of each developing roller and each developer screw from the settings for during normal image formation, whether or not the formula a is satisfied is examined will be described. FIG. 11 is a graph showing the results. A horizontal axis in FIG. 11 represents, when the driving speeds of the first developing roller 30 and the second developing roller 31 (developing rollers) for the normal image formation (REF) are set as 100%, a speed ratio of driving speeds varied therefrom. A vertical axis represents, when the driving speeds of the developer supplying screw 42 and the developer stirring screw 43 (developer screws) for the normal image formation (REF) are set as 100%, a speed ratio of driving speeds varied therefrom.

For example, when the rotation speed of the first developing roller 30 during normal image formation is set to 680 rpm and the varied speed is set to 340 rpm, the speed ratio becomes 340 rpm/680 rpm×100%=50%. In addition, when the rotation speed of the developer supplying screw 42 during normal image formation is set to 900 rpm and the varied speed is set to 600 rpm, the speed ratio becomes 600 rpm/900 rpm×100%=66.7%.

In addition, in FIG. 11, a peripheral speed ratio of the developing roller and a peripheral speed ratio of the developer screw are varied from 100% with respect to the rotation speeds thereof during normal image formation, and setting points which satisfy the formula a are plotted. A broken line in the graph represents an approximate straight line for these plots, and shows a relationship between the peripheral speed ratio of the developing roller and the peripheral speed ratio of the developer screw, which satisfies the formula a. In addition, a graph of a solid line in FIG. 11 is a graph of which the relationship between the peripheral speed ratio of the developing roller and the peripheral speed ratio of the developer screw is 1:1. Incidentally, in a case in which there are some kinds of the settings for the rotation speeds for the developing roller and the developer screw during normal image formation, maximum speeds in a state in which the image forming apparatus starts to be used is set as 100%. In a case in which there is a condition in which the image formation is performed with changing the settings for the rotation speed from 100% to 80% depending on a type of a medium for the image formation and/or a used state of the image forming apparatus, the speed of 80% is considered as the speed for the normal image formation (REF).

According to the graph in FIG. 11, it is found that upon changing the driving speeds of the developer supplying screw 42 and the developer stirring screw 43 from the speeds during normal image formation to a lower speed side by 29% or more, the formula a described above is satisfied. By satisfying the formula a described above, it becomes possible to efficiently collect the scattered toner and developer without causing the inside of the developing container 70 to be the positive pressure state. For example, upon operating the vibration applying device 501 which collects the scattered toner, in a state in which while the rotation speeds of the first developing roller 30, the second developing roller 31, the separating roller 32 and the developer collecting screw 44 being kept at the same rotation speeds as the normal condition, the rotation speeds of the developer supplying screw 42 and the developer stirring screw 43 are reduced by 35% compared to the normal condition, the vibration applying device 501 and the fan 69 are operated. In this case, since it is the setting which satisfies the formula «, it becomes possible to efficiently collect the scattered toner without the developing container 70 becoming the positive pressure state, and suppress the defect caused by the scattered toner and/or the aggregated lump by breaking up the stationary layer and the aggregated lump inside the developing device.

Incidentally, even in a case in which the driving speeds of the developer supplying screw 42 and the developer stirring screw 43 are changed from the speeds during normal image formation to the lower speed side by 20%, though the inside of the developing container 70 becomes a slight positive pressure, it becomes possible to suppress the toner scattering to an acceptable degree. Therefore, it may be a configuration in which, upon the vibration applying operation, the rotation speed of the developer supplying screw 42 is reduced by 20% or more with respect to the rotation speed of the developer supplying screw 42 during image formation. In addition, upon the vibration applying operation, by reducing the rotation speed of the developer supplying screw 42 even slightly slower than during image formation, it becomes possible to suppress the toner scattering compared to a case in which the rotation speed thereof is not changed.

In addition, in the present Embodiment as well, in the case in which the image forming operation is executed after the vibration applying operation by the vibration applying device 501 is performed, “the sequence for the restoration” described in the Embodiment 1 is executed. However, in the present Embodiment, unlike the Embodiment 1, since the driving motor M2 is not stopped upon the vibration applying operation, degree of the unbalance of the developer inside the developing container 70 is less compared to the Embodiment 1. Therefore, it becomes possible to shorten the time required for the sequence for the restoration. For example, as described above, under the driving setting in which the rotation speeds of the developer supplying screw 42 and the developer stirring screw 43 are reduced by 35% than during normal image formation, while the developer balance inside the developing container 70 is unbalanced, compared to the state in the Embodiment 1, it is in a state closer to the developer balance during normal image formation. Therefore, it becomes possible to set the time for the sequence for the restoration, which takes 10 seconds in the Embodiment 1, to 5 seconds or less. As described above, in the present Embodiment, by optimizing the driving settings which satisfy the formula a, it becomes possible to shorten the sequence for the restoration, which is required to adjust the developer balance inside the developing container 70, thereby improving the productivity.

### Embodiment 3

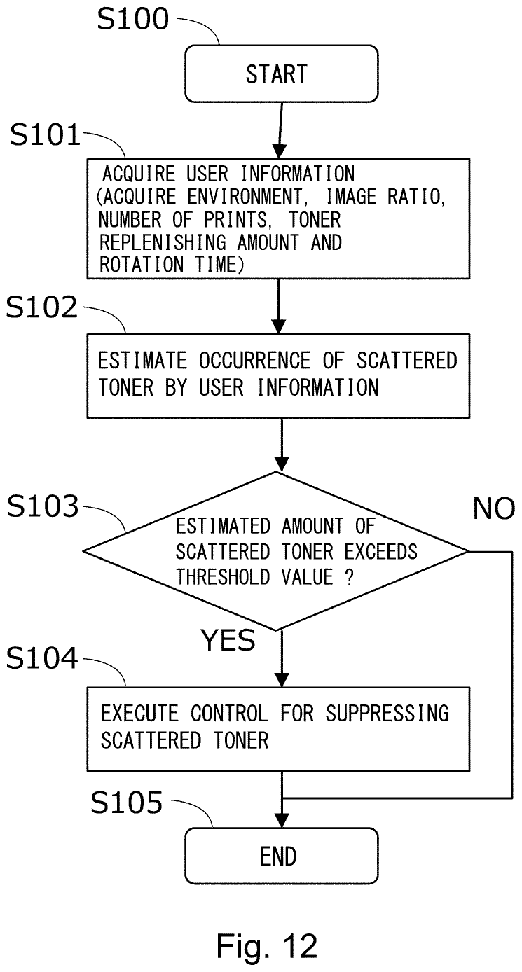

An Embodiment 3 will be described using FIG. 12 while referring to each Figure described above. In the Embodiments 1 and 2 described above, the configurations in which, upon performing the vibration applying operation, while the driving motor M1, which drives the first and second developing rollers 30 and 31, the separating roller 32 and the developer collecting screw 44, is kept rotationally driven at the same speed as during image formation, the driving of the driving motor M2, which drives the developer supplying screw 42 and the developer stirring screw 43, is turned off or slowed down than during image formation are described. In the present Embodiment, timing at which the vibration applying operation is performed is optimized. Since the other configurations and actions are the same as those in the Embodiment 1 or the Embodiment 2 described above, the same reference numerals will be used for the same configurations and description and illustrations thereof will be omitted or simplified, and hereinafter, points which differ from the Embodiment 1 and the Embodiment 2 will be mainly described.

In the case in which the control for the vibration applying operation and the sequence for the restoration for suppressing the defect caused by the scattered toner described above are executed, the productivity is decreased to not a little extent. In order to prevent the decrease in the productivity as much as possible, it is required that the timing, at which the control for the vibration applying operation and/or the control for changing the setting for the driving motor is executed, be optimized. Therefore, in the present Embodiment, a configuration in which the occurrence of the defect caused by the scattered toner is estimated based on various types of information, and executing timing of the control for the vibration applying operation is optimized will be described.

Upon analyzing the scattered toner, it is found that, as described above, by the fine powders of titanium oxide, silica, etc. added to the surface of the toner being liberated, the amount of the fine powder on the surface of the toner is changed, so that there are much toner of which the chargeability and/or the flowability deviates from the appropriate range. In addition, as for the carrier in the developer as well, much spent (contamination) is adhered thereto, which causes lowering in the chargeability of the toner. Upon examining under what kinds of conditions the liberation of the fine powders of titanium oxide, silica, etc. added to the surface of the toner and the spent of the carrier occur, it is found that a toner area ratio (image ratio) in an image which a user outputs, a number of sheets on which the image is formed, numbers of rotation (travel distance) of the first developing roller 30, the second developing roller 31 and the separating roller 32, a temperature, a humidity and a liquid content under which the developing device is used, have a significant influence.

Thus, these kinds of information are detected and recorded by sensors and the controller 500 in the image forming apparatus. Based on these kinds of information, the occurrence of the defect caused by the scattered toner and the aggregated lump is estimated, and the control for suppressing the defect caused by the scattered toner and the aggregated lump is executed. FIG. 12 is a control flowchart for executing a control which estimates a timing of the occurrence of the defect caused by the scattered toner and the aggregated lump to avoid the occurrence of the defect.

As shown in FIG. 12, first, the controller 500 starts the image formation by receiving information on the image formation from a user (S100). Upon starting the image formation, detection results from the various types of sensors and input information from the user are aggregated to the controller 500. Specifically, the controller 500 acquires environment information such as the temperature, the humidity and the liquid content, to which the image forming apparatus is exposed, the toner amount ratio (image ratio) in the image, the toner replenishing amount, the number of sheets on which the image is output, the travel distance of the developing roller and a value from the toner density detecting sensor for the developer (S101). As for the image ratio, there are an image ratio since the use of the image forming apparatus is started, an image ratio since a service representative performs maintenance for the developing device 1Y, and an image ratio since a previous control for suppressing the defect caused by the scattered toner is executed. As for the toner replenishing amount, there are a toner replenishing amount since the use of the image forming apparatus is started, a toner replenishing amount since the service representative performs the maintenance for the developing device 1Y, and a toner replenishing amount since the previous control for suppressing the defect caused by the scattered toner is executed. As for the number of sheets on which the image is output, there are a total number of sheets since the use of the image forming apparatus is started, a total number of sheets since the service representative performed the maintenance for the developing device 1Y, a total number of sheets since the previous control for suppressing the defect caused by the scattered toner is executed. As for the travel distance of the developing roller, there are a total travel distance since the use of the image forming apparatus is started, a total travel distance since the service representative performs the maintenance for the developing device 1Y, a total travel distance since the previous control for suppressing the defect caused by the scattered toner is executed.

The controller 500 calculates a deteriorated state of the toner based on these kinds of information, and performs the estimation for the occurrence of the scattered toner and the aggregated lump, which occur due to the deterioration (S102). And the controller 500 determines whether or not a calculated estimation value for the occurrence of the scattered toner exceeds a threshold value (S103). In S103, if the calculated amount of the scattered toner exceeds the threshold value (YES in S103), then as the control for collecting the scattering toner, the controller 500 sets the operation for the fan 69 to collect the scattering toner, changes the settings for the driving motors M1 and M2, and executes the control, which operates the vibration applying device 501 and is described in the above Embodiments, for suppressing the scattered toner (S104). On the other hand, in S103, if the calculated amount of the scattered toner does not exceed the threshold value (NO in S103), then the controller 500 performs the image formation without executing S104, and ends the process without performing any other controls (S105).

By introducing the control flowchart in FIG. 12, while in the Embodiments 1 and 2, once every 2000 sheets, for example, the settings for the vibration applying device 501 and the driving motors M1 and M2 are changed to suppress the defect caused by the scattered toner, however, it becomes possible, according to the image ratio, the temperature and the humidity under which the image formation is performed, etc, to make the timing, at which the control for preventing the scattered toner is executed, variable from 2000 sheets up to 9000 sheets. By this, it becomes possible to reduce a downtime in the image forming apparatus and improve the productivity.

Incidentally, in order to maintain the productivity in a case in which a large number of the images are continuously formed at once, for a case in which the image forming operation is once stopped and then the control for suppressing the scattered toner is executed, and for a case in which the control for suppressing the scattered toner is executed after the image forming operation is completed, the threshold values in S103 described above are provided, respectively. In addition, the control for suppressing the defect caused by the scattered toner and/or the aggregated lump can be executed, as appropriately, with adjusting contents of the control and the timings thereof, such as a case in which all of the controls for setting the operation for the fan to collect the scattering toner, changing the settings for the driving motors M1 and M2, and operating the vibration applying device 501 are executed, a case in which only the operation setting for collecting the scattering toner is executed, and a case in which the control which only changes the settings for the driving motors M1 and M2 is executed, corresponding to a situation of the estimated scattered toner and the aggregated lump.

As described above, by executing the control for suppressing the defect caused by the scattered toner and/or the aggregated lump at an appropriate timing, it becomes possible, while minimizing the lowering in productivity of the image forming apparatus, to prevent the occurrence of the defect caused by the scattered toner.

### OTHER EMBODIMENTS

The present invention is not limited to the configurations described in the Embodiments described above. For example, the image forming apparatus 100 is not limited to the MFP, but may be a copy machine, a printer or a facsimile device. In addition, the configurations of the developer supplying screw 42, the developer stirring screw 43 and the developer collecting screw 44 are not specifically limited as long as these screws can feed the developer, and for example, helical blades and blades having a paddle shape can be applied thereto.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-002144, filed on Jan. 7, 2025, which is hereby incorporated by reference herein in its entirety.

What is claimed is:

1. An image forming apparatus comprising:
an image bearing member;
a developing device provided with a developing container for accommodating a developer including toner and a carrier, a rotatable developing member for carrying and feeding the developer to develop an electrostatic latent image formed on the image bearing member and a supplying screw for supplying the developer to the rotatable developing member while feeding the developer;
a sucking portion configured to suck the developer scattered inside the developing container;
a vibration applying portion configured to apply vibration to the developing container;
a first driving portion configured to rotationally drive the rotatable developing member;
a second driving portion configured to rotationally drive the supplying screw; and
a controller,
wherein at start of a vibration applying operation by the vibration applying portion, the controller controls the first driving portion so as to become a state in which the rotatable developing member is rotationally driven, and controls the second driving portion so as to become a state in which rotational drive of the supplying screw is stopped.

2. The image forming apparatus according to claim 1, wherein the controller controls the vibration applying portion so as to start the vibration applying operation after becoming the state in which the rotatable developing member is rotationally driven and the state in which the rotational drive of the supplying screw is stopped.

3. The image forming apparatus according to claim 1, wherein in a period from the start of the vibration applying operation until completion of the vibration applying operation, the controller controls the first driving portion so as to become the state in which the rotatable developing member is rotationally driven and controls the second driving portion so as to become the state in which the rotational drive of the supplying screw is stopped.

4. The image forming apparatus according to claim 1, wherein after completion of the vibration applying operation and before start of an image forming operation, the controller controls the first driving portion so as to become the state in which the rotatable developing member is rotationally driven and controls the second driving portion so as to become a state in which the supplying screw is rotationally driven.

5. The image forming apparatus according to claim 1, wherein after completion of the vibration applying operation and before start of an image forming operation, the controller controls the first driving portion so as to become a state in which the rotatable developing member is rotationally driven at a first speed, and controls the second driving portion so as to become a state in which the supplying screw is rotationally driven at a second speed, and then,
at the start of the image forming operation, the controller controls the first driving portion so as to become a state in which the rotatable developing member is rotationally driven at a third speed faster than the first speed, and controls the second driving portion so as to become a state in which the supplying screw is rotationally driven at a fourth speed faster than the second speed.

6. The image forming apparatus according to claim 1, wherein after completion of the vibration applying operation and before start of an image forming operation, the controller controls the first driving portion so as to become a state in which the rotatable developing member is rotationally driven at a first speed, and controls the second driving portion so as to become a state in which the supplying screw is rotationally driven at a second speed, and then,
at the start of the image forming operation, the controller controls the first driving portion so as to become a state in which the rotatable developing member is rotationally driven at a third speed slower than the first speed, and controls the second driving portion so as to become a state in which the supplying screw is rotationally driven at a fourth speed slower than the second speed.

7. The image forming apparatus according to claim 1, wherein the developing device is further provided with a rotatable separating member disposed opposite to the rotatable developing member and configured to separate the developer remaining after the electrostatic latent image being developed by the rotatable developing member, from the rotatable developing member,
wherein the first driving portion rotationally drives the rotatable developing member and the rotatable separating member, and
wherein at the start of the vibration applying operation, the controller controls the first driving portion so as to become a state in which the rotatable developing member and the rotatable separating member are rotationally driven, and controls the second driving portion so as to become a state in which the rotational drive of the supplying screw is stopped.

8. An image forming apparatus comprising:
an image bearing member;
a developing device provided with a developing container for accommodating a developer including toner and a carrier, a rotatable developing member for carrying and feeding the developer to develop an electrostatic latent image formed on the image bearing member and a supplying screw for supplying the developer to the rotatable developing member while feeding the developer;
a sucking portion configured to suck the developer scattered inside the developing container;
a vibration applying portion configured to apply vibration to the developing container;
a first driving portion configured to rotationally drive the rotatable developing member;
a second driving portion configured to rotationally drive the supplying screw; and
a controller,
wherein during an image forming operation, the controller controls the first driving portion so as to become a state in which the rotatable developing member is rotationally driven at a first speed, and controls the second driving portion so as to become a state in which the supplying screw is rotationally driven at a second speed, and
wherein at start of the vibration applying operation by the vibration applying portion, the controller controls the first driving portion so as to become the state in which the rotatable developing member is rotationally driven at the first speed, and controls the second driving portion so as to become a state in which the supplying screw is rotationally driven at a third speed slower than the second speed.

9. The image forming apparatus according to claim 8, wherein the controller controls the vibration applying portion so as to start the vibration applying operation after becoming the state in which the rotatable developing member is rotationally driven at the first speed and the state in which the supplying screw is rotationally driven at the third speed.

10. The image forming apparatus according to claim 8, wherein in a period from the start of the vibration applying operation until completion of the vibration applying operation, the controller controls the first driving portion so as to become the state in which the rotatable developing member is rotationally driven at the first speed and controls the second driving portion so as to become the state in which the supplying screw is rotationally driven at the third speed.

11. The image forming apparatus according to claim 8, wherein the developing device is further provided with a rotatable separating member disposed opposite to the rotatable developing member and configured to separate the developer remaining after the electrostatic latent image being developed by the rotatable developing member, from the rotatable developing member,
wherein the first driving portion rotationally drives the rotatable developing member and the rotatable separating member, and
wherein at the start of the vibration applying operation, the controller controls the first driving portion so as to become a state in which the rotatable developing member and the rotatable separating member are rotationally driven at the first speed, and controls the second driving portion so as to become the state in which the supplying screw is rotationally driven at the third speed.

12. The image forming apparatus according to claim 8, wherein the third speed is 20% or more slower than the second speed.

13. The image forming apparatus according to claim 12, wherein the third speed is 29% or more slower than the second speed.

14. An image forming apparatus comprising:
an image bearing member;
a developing device provided with a developing container for accommodating a developer including toner and a carrier, a first rotatable developing member for carrying and feeding the developer to develop an electrostatic latent image formed on the image bearing member, a second rotatable developing member disposed opposite to the first rotatable developing member and to which the developer remaining after the electrostatic latent image being developed by the first rotatable developing member is delivered, the second rotatable developing member carrying and deeding the developer to develop the electrostatic latent image by the second rotatable developing member after the electrostatic latent image being developed by the first rotatable developing member, and a supplying screw for supplying the developer to the first rotatable developing member while feeding the developer;
a sucking portion configured to suck the developer scattered inside the developing container;
a vibration applying portion configured to apply vibration to the developing container;
a first driving portion configured to rotationally drive the first rotatable developing member and the second rotatable developing member;
a second driving portion configured to rotationally drive the supplying screw; and
a controller,
wherein at start of the vibration applying operation by the vibration applying portion, the controller controls the first driving portion so as to become a state in which the first rotatable developing member and the second rotatable developing member are rotationally driven, and controls the second driving portion so as to become a state in which rotational drive of the supplying screw is stopped.

15. The image forming apparatus according to claim 14, wherein the controller controls the vibration applying portion so as to start the vibration applying operation after becoming the state in which the first rotatable developing member and the second rotatable developing member are rotationally driven and the state in which the rotational drive of the supplying screw is stopped.

16. The image forming apparatus according to claim 14, wherein in a period from the start of the vibration applying operation until completion of the vibration applying operation, the controller controls the first driving portion so as to become the state in which the first rotatable developing member and the second rotatable developing member are rotationally driven and controls the second driving portion so as to become the state in which the rotational drive of the supplying screw is stopped.

17. The image forming apparatus according to claim 14, wherein after completion of the vibration applying operation and before start of an image forming operation, the controller controls the first driving portion so as to become the state in which the first rotatable developing member and the second rotatable developing member are rotationally driven and controls the second driving portion so as to become a state in which the supplying screw is rotationally driven.

18. The image forming apparatus according to claim 14, wherein after completion of the vibration applying operation and before start of an image forming operation, the controller controls the first driving portion so as to become a state in which the first rotatable developing member and the second rotatable developing member are rotationally driven at a first speed, and controls the second driving portion so as to become a state in which the supplying screw is rotationally driven at a second speed, and then,
at the start of the image forming operation, the controller controls the first driving portion so as to become a state in which the first rotatable developing member and the second rotatable developing member are rotationally driven at a third speed faster than the first speed, and controls the second driving portion so as to become a state in which the supplying screw is rotationally driven at a fourth speed faster than the second speed.

19. The image forming apparatus according to claim 14, wherein after completion of the vibration applying operation and before start of an image forming operation, the controller controls the first driving portion so as to become a state in which the first rotatable developing member and the second rotatable developing member are rotationally driven at a first speed, and controls the second driving portion so as to become a state in which the supplying screw is rotationally driven at a second speed, and then,
at the start of the image forming operation, the controller controls the first driving portion so as to become a state in which the first rotatable developing member and the second rotatable developing member are rotationally driven at a third speed slower than the first speed, and controls the second driving portion so as to become a state in which the supplying screw is rotationally driven at a fourth speed slower than the second speed.

20. The image forming apparatus according to claim 14, wherein the developing device is further provided with a rotatable separating member disposed opposite to the second rotatable developing member and configured to separate the developer remaining after the electrostatic latent image being developed by the second rotatable developing member, from the second rotatable developing member,
wherein the first driving portion rotationally drives the first rotatable developing member, the second rotatable developing member and the rotatable separating member, and
wherein at the start of the vibration applying operation, the controller controls the first driving portion so as to become a state in which the first rotatable developing member, the second rotatable developing member and the rotatable separating member are rotationally driven, and controls the second driving portion so as to become a state in which the rotational drive of the supplying screw is stopped.
